(19) United States
(12) Patent Application Publication
(10) Pub. No.: US 2026/0343134 A1
(43) Pub. Date: Oct. 29, 2026

(54) OPTIMIZATION IN ACTIVE NOISE CANCELATION (ANC)-ENABLED AUDIO OUTPUT DEVICE

(71) Applicant: QUALCOMM Incorporated, San Diego, CA (US)

(72) Inventors: Hari Prasad NARASIMHAIAH, Bangalore (IN); Rahul GUPTA, KANPUR (IN); Rajat KUMAR, Bengaluru (IN)

(21) Appl. No.: 19/191,199

(22) Filed: Apr. 28, 2025

(51) Int. Cl. H04R 1/10; H04R 3/02

(52) U.S. Cl. CPC H04R 1/1083; H04R 3/02

(57) ABSTRACT

Aspects relate to active noise cancelation (ANC)-enabled audio output device. The audio output device includes a feed-forward circuit that detects first ambient sound information, and a feedback circuit that detects in-ear sound information. The audio output device transitions from a non-quiet mode to a quiet mode based on the detected first ambient sound information, and disables the feedback circuit based on the transition to the quiet mode.

### BACKGROUND

### Field of the Disclosure

The present disclosure relates generally to audio signal processing, and, more particularly, to active noise cancelation in audio signals.

### Description of Related Art

Hearable devices, also known as hearables (such as headphones and earphones) are widely used across various applications, including music playback, gaming, communication, enhancing auditory experiences for individuals with hearing impairments, or the like. These hearables can be worn over the ear, on the ear, or in the ear. Many hearables incorporate Active Noise Cancelation (ANC) to reduce ambient noise in noisy environments, such as airplanes, noisy public spaces, or open space offices, enhancing the overall listening experience.

ANC-enabled hearables utilize a combination of feed-forward circuit and feedback circuit to achieve noise cancelation. The feed-forward circuit uses out-ear microphones to detect ambient noise before the noise reaches the ear. In parallel, the feedback circuit uses in-ear microphones to detect residual noise that manages to bypass noise cancelation. Since ANC-enabled hearables integrate multiple power-consuming components, there are opportunities to optimize power consumption and enhance battery efficiency.

### SUMMARY

Aspects of the disclosure provide an audio output device. The audio output includes a feed-forward circuit configured to detect first ambient sound information. The audio output device includes a feedback circuit configured to detect in-ear sound information. The audio output device includes one or more memories and one or more processors coupled to the one or more memories. The one or more processors are individually or collectively configured to transition from a non-quiet mode to a quiet mode based on the detected first ambient sound information. The one or more processors are individually or collectively configured to disable the feedback circuit based on the transition to the quiet mode.

In certain aspects, an audio output device is provided. The audio output device includes an out-ear microphone configured to detect first ambient sound information. The audio output device comprises an in-ear microphone configured to detect in-ear sound information. The audio output device comprises one or more memories and one or more processors coupled to the one or more memories. The one or more processors are individually or collectively configured to transition from a non-quiet mode to a quiet mode based on the detected first ambient sound information. The one or more processors are individually or collectively configured to disable the in-ear microphone based on the transition to the quiet mode.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates a user wearing an active noise cancelation (ANC)-enabled audio output device, in accordance with certain aspects of the present disclosure;

FIG. 2 is a block diagram illustrating an ANC-enabled audio output device, in accordance with certain aspects of the present disclosure;

FIG. 3 is a block diagram illustrating an audio output device coupled with an ANC control device, in accordance with certain aspects of the present disclosure;

FIG. 4 is a flow diagram that illustrates an example scenario for optimization of an ANC-enabled audio output device, in accordance with certain aspects of the present disclosure;

FIG. 5 is a flowchart that illustrates a method (e.g., a process) for optimization of an ANC-enabled audio output device, in accordance with certain aspects of the present disclosure;

FIG. 6 is a flowchart that illustrates a method (e.g., a process) for managing a quiet mode and a non-quiet mode in an ANC-enabled audio output device based on at least one sound profile, in accordance with certain aspects of the present disclosure;

FIG. 7 is a flowchart that illustrates a method (e.g., a process) for managing a quiet mode and a non-quiet mode in an ANC-enabled audio output device based on a sound threshold, in accordance with certain aspects of the present disclosure;

FIG. 8 is a flowchart that illustrates a method (e.g., a process) for managing a quiet mode and a non-quiet mode in an ANC-enabled audio output device based on a sound threshold and a configured time-period, in accordance with certain aspects of the present disclosure;

FIG. 9 is a flowchart that illustrates a method (e.g., a process) for managing a quiet mode and a non-quiet mode in an ANC-enabled audio output device based on a sound threshold and one or more sound profiles, in accordance with certain aspects of the present disclosure;

FIG. 10 is a diagram that illustrates an example implementation of a wearable device configured to perform optimized ANC, in accordance with certain aspects of the present disclosure;

FIG. 11 is a diagram that illustrates an example implementation of a portable electronic device configured to perform optimized ANC, in accordance with certain aspects of the present disclosure; and

FIG. 12 is a block diagram of an example implementation of a device, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and a method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Hearable devices or hearables, for example, headphones and earphones, are used widely across various applications such as music playback, gaming, communication, enhancing auditory experiences for individuals with hearing impairments, or the like. Many modern hearables are equipped with Active Noise Cancelation (ANC) technology to minimize external noise and enhance user experience. In many examples, ANC-enabled hearables include a feed-forward circuit and a feedback circuit. The feed-forward circuit uses external or out-ear microphones to detect ambient noise, and the feedback circuit uses internal or in-ear microphones to detect residual noise that manages to bypass noise cancelation. By dynamically adjusting the gain and phase in the feed-forward circuit and the feedback circuit, unwanted external sounds are effectively suppressed.

To optimize performance, ANC-enabled hearables adjust their operation based on ambient noise levels. For example, in louder environments, higher gain settings are applied to the feed-forward circuit and the feedback circuit to maximize noise cancelation, whereas, in quieter scenarios, the gains in the feed-forward circuit and the feedback circuit can be reduced to avoid overcompensation. In such low-noise conditions, the ANC-enabled hearables can also freeze adaptivity (e.g., dynamically adjusting the gains of the feed-forward circuit and the feedback circuit based on changing noise conditions) as continuous gain adjustments may be unnecessary.

In low-noise conditions, although the gains of the feed-forward circuit and the feedback circuit may be significantly reduced, both the feed-forward circuit and feedback circuit remain active. While the out-ear or external microphones may remain operational to monitor ambient noise levels and enable appropriate gain adjustments, the in-ear or internal microphones, although active, contribute minimally to the noise cancelation process in low noise scenarios. Thus, keeping the feedback circuit active across all ANC use cases leads to additional power consumption and introduces the potential for electrical noise, which may be perceptible in quieter environments, thereby degrading the overall listening experience. Additionally, as ANC-enabled hearables are predominantly battery-powered devices, this additional and unnecessary power consumption can lead to reduced battery life, impacting overall device longevity and user satisfaction.

To address the aforementioned issues, along with other inefficiencies that affect performance and user experience, various aspects of the present disclosure provide a technical solution to optimize ANC-enabled audio output devices (for example, hearable devices or hearables). In many aspects, an audio output device may include a feed-forward circuit and a feedback circuit. The feed-forward circuit may detect ambient sound information, while the feedback circuit may detect in-ear sound information. The audio output device may include one or more memories that store a plurality of mode configurations including a quiet mode and a non-quiet mode. The audio output device may also include one or more processors coupled to the one or more memories to enable various operations of the audio output device.

In various aspects, the audio output device may transition from a non-quiet mode to a quiet mode based on the ambient sound information detected by the feed-forward circuit. The audio output device may disable the feedback circuit based on the transition to the quiet mode. For example, when a user wearing ANC-enabled earphones moves to a quieter environment, the earphones may transition (or switch) to the quiet mode in which the feedback circuit may be temporarily disabled and the feed-forward circuit may continue to operate. Such selective disabling of the feedback circuit in the quiet mode may reduce power consumption of the audio output device and also prevent electrical noise. As a result, the battery life of the audio output device may extend, allowing for longer usage between charges. By improving battery life through optimized ANC operation, the overall playback time of the audio output device may be extended. Such an enhancement may allow users to enjoy extended usage periods without the need for frequent recharging, making the audio output device more reliable and convenient for prolonged use.

In many aspects, the transition from the non-quiet mode to the quiet mode may be based on the detected first ambient sound information satisfying a condition associated with a sound profile or a sound threshold. While in the quiet mode, the feed-forward circuit, which is active, may detect second ambient sound information. In many aspects, the audio output device may transition from the quiet mode to the non-quiet mode based on the second ambient sound information and enable the feedback circuit based on the transition to the non-quiet mode. In an example, the audio output device may transition from the quiet mode to the non-quiet mode based on a similarity index between the detected second ambient sound information and the sound profile being below the threshold value. However, if the similarity index between the detected second ambient sound information and the sound profile exceeds the threshold value, the audio output device may maintain the quiet mode. In more examples, the audio output device may transition from the quiet mode to the non-quiet mode based on the detected second ambient sound information exceeding the sound threshold. However, if the detected second ambient sound information is below the sound threshold, the audio output device may maintain the quiet mode.

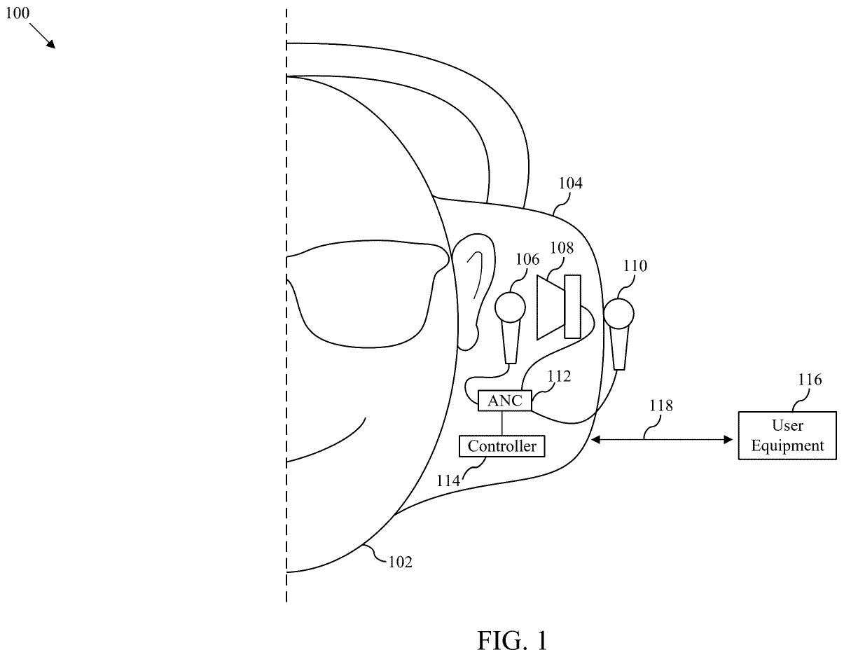

FIG. 1 is a diagram 100 that illustrates a user wearing an active noise cancelation (ANC)-enabled audio output device, in accordance with certain aspects of the present disclosure. The diagram 100 illustrates a user 102 wearing an audio output device 104. The audio output device 104 may include an internal microphone 106, a speaker 108, an external microphone 110, an ANC circuit 112, and a controller 114.

In various aspects, the audio output device 104 can be headphones, earphones, or similar audio equipment distinguished by the type of fitting on an ear of the user. In the example embodiment illustrated in FIG. 1, the audio output device 104 is depicted as over-ear headphones; however, the scope of the disclosure is not limited to it. Various additional non-limiting examples of the audio output device 104 with ANC capability may include on-ear headphones, in-ear earphones, neckband earphones, earbuds, and hearing aids.

In many aspects, the internal microphone 106 may be positioned inside the audio output device 104 to detect in-ear noise (e.g., in-ear sound information). For example, the internal microphone 106 may detect residual noise that manages to bypass noise cancelation and reaches the ear of the user 102. In various aspects, the external microphone 110 may be configured to detect out-ear noise (such as ambient sound information external to the audio output device 104). The audio output device 104 may utilize the internal microphone 106 and the external microphone 110 to analyze noise (e.g., the in-ear noise and the out-ear noise) and determine modifications to minimize the noise from entering the ear of the user 102.

In various aspects, the ANC circuit 112 may be coupled to the internal microphone 106, the speaker 108, and the external microphone 110. The ANC circuit 112 may be configured to process the out-ear noise detected by the external microphone 110 and the in-ear noise detected by the internal microphone 106, and then generate an anti-noise signal that cancels the out-ear noise and the in-ear noise.

In various aspects, the controller 114 may be coupled to the ANC circuit 112. In more aspects, the controller 114 can be implemented using various types of processing units (e.g., processors), for example, microprocessors (MPUs), microcontrollers (MCUs), application-specific integrated circuits (ASICs), complex instruction set computing (CISC) processors, reduced instruction set computing (RISC) processors, digital signal processors (DSPs), field-programmable gate arrays (FPGAs), or the like. Though the controller 114 and the ANC circuit 112 are shown as standalone components in FIG. 1, the scope of the disclosure may not be limited to it. For example, in some aspects, the controller 114 may be configured to execute various operations of the ANC circuit 112. In certain aspects, ANC logic implemented by the ANC circuit 112 and control logic implemented by the controller 114 may be integrated within the same processing unit.

In several aspects, the controller 114 may be configured to control the operations of the internal microphone 106, the speaker 108, the external microphone 110, and the ANC circuit 112. For example, using the internal microphone 106, the speaker 108, the external microphone 110, and the ANC circuit 112, the controller 114 may be configured to apply ANC to an audio signal and obtain an active noise-canceled version of the audio signal. The audio signal may be a composite signal that includes a desired audio output, in-ear noise, and out-ear noise. To apply ANC to the audio signal, the controller 114 may cause the ANC circuit 112 to generate the anti-noise signal and then cause the speaker 108 to output the anti-noise signal along with the desired audio output. The anti-noise signal cancels out (or suppresses) the in-ear noise and the out-ear noise, resulting in an active noise-canceled version of the audio signal that preserves the desired audio output for the user 102. The desired audio output may include music, spoken words, or other sounds.

In several aspects, the controller 114 may be configured to manage one or more ANC settings and operational features of the audio output device 104. The ANC settings and operational features may include a plurality of mode configurations that determine how the audio output device 104 processes ambient noise and delivers audio to the user 102. In an example, the plurality of mode configurations may include ANC-enabled modes such as a quiet mode and a non-quiet mode, where ANC is used to reduce ambient noise to different extents. Additional mode configurations may include an ANC-disabled mode where the ANC circuit 112 is turned off, resulting in an audio output being rendered without noise cancelation, a transparency mode where ambient sound is actively passed through and mixed with a desired audio output, or the like.

In many aspects, the controller 114 may enable manual and automatic operations of the audio output device 104. In manual operation, various functions, such as adjusting a volume or selecting a mode configuration (e.g., the quiet mode, the non-quiet mode, the transparency mode, or the ANC-disabled mode), may be controlled based on one or more setting inputs provided by the user 102. In automatic operation, the controller 114 may automatically execute these functions. For example, the controller 114 may automatically adjust the volume and select an appropriate mode configuration, allowing an optimal listening experience without requiring user intervention.

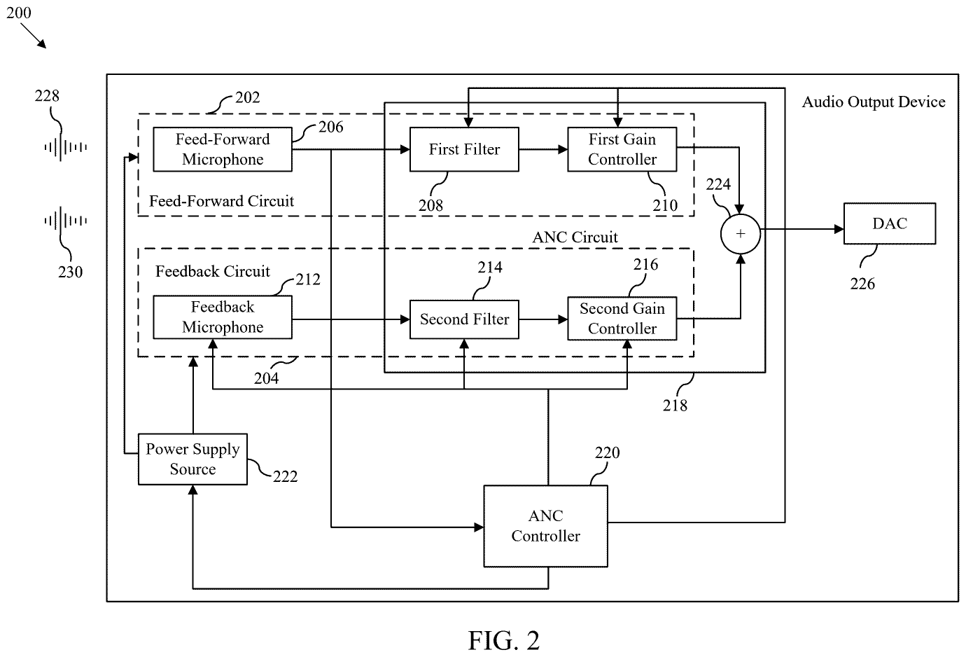

In various aspects, the controller 114 may be configured to control the operations of the internal microphone 106 and the external microphone 110 based on ambient noise levels. For example, when the out-ear noise (e.g., ambient sound information) detected by the external microphone 110 indicates a noisy environment, the controller 114 may operate the audio output device 104 in the non-quiet mode. In the non-quiet mode, both the internal microphone 106 and the external microphone 110 are enabled for noise detection. However, if the out-ear noise detected by the external microphone 110 decreases, for example, to a level where the environment can be classified as quiet, the controller 114 may dynamically transition from the non-quiet mode to the quiet mode and disable the internal microphone 106 based on the transition to the quiet mode. Since the controller 114 does not disable the external microphone 110, the external microphone 110 may remain enabled and continue detecting out-ear noise. Such selective disabling of the internal microphone 106 in the quiet mode may reduce power consumption of the audio output device 104 and also prevent electrical noise. As a result, the battery life of the audio output device 104 may be extended, allowing for longer usage between charges. By improving battery life through optimized ANC operation, the overall playback time of the audio output device 104 can be extended. Such an enhancement may allow the user 102 to enjoy extended usage periods without the need for frequent recharging, making the audio output device 104 more reliable and convenient for prolonged use. The quiet mode and the non-quiet mode are further described in detail in conjunction with FIG. 2-9.

In additional aspects, the audio output device 104 may be operatively coupled to a user equipment (UE) 116 via a communication channel 118. Examples of the UE 116 may include, but are not limited only to a smartphone, a tablet, a phablet, a laptop, a gaming console, a television, a multimedia player, computer, or the like. The communication channel 118 may facilitate streaming of the desired audio output from the UE 116 to the audio output device 104. In an audio playback use case, the UE 116 may serve as a primary source of the desired audio output, which may include music, podcasts, movies, calls, or game audio. The UE 116 may be configured to encode and transmit the desired audio output over the communication channel 118, which may be established using wireless technologies such as Bluetooth®, Wi-Fi®, or similar communication protocols. In many aspects, a wired connection, such as a Universal Serial Bus (USB®) or an audio jack, may be utilized to establish the communication channel 118. In many aspects, the UE 116 may enable control and management of audio playback experience of the user 102. For example, the UE 116 may allow the user 102 to select the desired audio output, adjust volume, and transition between the different mode configurations (such as the quiet mode, the non-quiet mode, the transparency mode, or the ANC-disabled mode). Additionally, the UE 116 may transmit control signals to the audio output device 104 to adjust various operational parameters, such as enabling or disabling ANC or activating voice assistants.

Although the audio output device 104 is depicted as including one internal microphone 106 and one external microphone 110, the scope of the disclosure is not limited to this configuration. Various implementations may include multiple microphones positioned at different locations to enhance the effectiveness of ANC. For example, additional external microphones (e.g., an external microphone array) may be placed on different areas of a housing of the audio output device 104 to capture ambient noise more accurately from different directions. Similarly, multiple internal microphones (e.g., an internal microphone array) may be positioned at different points within the ear canal to monitor in-ear noise and residual feedback more effectively.

FIG. 2 is a block diagram illustrating an ANC-enabled audio output device, in accordance with certain aspects of the present disclosure. FIG. 2 is described in conjunction with FIG. 1. Referring to FIG. 2, an audio output device 200 with ANC is shown, which may be similar to the audio output device 104 shown in FIG. 1.

In various aspects, the audio output device 200 may include a feed-forward circuit 202 and a feedback circuit 204. The feed-forward circuit 202 may include a feed-forward microphone 206, a first filter 208, and a first gain controller 210. The feedback circuit 204 may include a feedback microphone 212, a second filter 214, and a second gain controller 216. The audio output device 200 may include an ANC controller 220, a power supply source 222, an anti-noise generator 224, and a digital-to-analog converter (DAC) 226. The first filter 208, the first gain controller 210, the second filter 214, the second gain controller 216, and the anti-noise generator 224 may collectively correspond to an ANC circuit 218. In many examples, the feed-forward microphone 206 and the feedback microphone 212 may be similar to the external microphone 110 and the internal microphone 106 of FIG. 1, respectively. The ANC circuit 218 may be similar to the ANC circuit 112 of FIG. 1 and the ANC controller 220 may be similar to controller 114 of FIG. 1.

In many aspects, the power supply source 222 may be coupled to various components, for example, the feed-forward circuit 202, the feedback circuit 204, the ANC controller 220, or the like to provide electrical power for their operation. In an example, the power supply source 222 may be implemented as a rechargeable battery.

In various aspects, the feed-forward circuit 202 may be configured to reduce external noise before the external noise reaches the ear of user, who is using the audio output device 200. In the feed-forward circuit 202, the feed-forward microphone 206 may be coupled to the first filter 208, and the first filter 208 may be coupled to the first gain controller 210. The feed-forward microphone 206 may correspond to an external or out-ear microphone placed on an outer surface of a housing of the audio output device 200. The feed-forward microphone 206, when active, may be configured to detect ambient sound information (e.g., out-ear noise as described in the foregoing description of FIG. 1) before the ambient sound enters the ear canal of the user. In an example, the detected ambient sound information may indicate various characteristics of the ambient sound. The characteristics may include an amplitude corresponding to a loudness of the ambient sound, a frequency corresponding to a pitch or tone of the ambient sound, and a phase indicating a timing or delay of a sound wave of the ambient sound relative to a reference point. In many examples, the feed-forward microphone 206 may output the detected ambient sound information in the form of a voltage signal that carries the amplitude, the frequency, and the phase of the ambient sound.

The feed-forward microphone 206 may transmit the detected ambient sound information to the first filter 208. In an example implementation, an analog to digital converter may be coupled between the feed-forward microphone 206 and the first filter 208. In such an implementation, the voltage signal outputted by the feed-forward microphone 206 may be converted to a digital signal by the analog to digital converter before providing to the first filter 208. The first filter 208 may be configured to process the detected ambient sound information. In an example, the first filter 208 may filter signal components corresponding to one or more frequencies from the voltage signal. The first filter 208 may be implemented as a software-based filter using DSP algorithms, for example, within the ANC controller 220, or as a hardware-based analog filter using various electronic components such as capacitors, resistors, operational amplifiers, or the like. The first filter 208 may transmit the processed ambient sound information to the first gain controller 210. The first gain controller 210 may be configured to adjust (e.g., increase or decrease) a gain (e.g., the amplitude) of the processed ambient sound information. For example, the first gain controller 210 may increase or decrease the gain (e.g., the amplitude) of the processed ambient sound information.

In various aspects, the feedback circuit 204 may be configured to detect residual in-ear noise that may not have been completely canceled by the feed-forward circuit 202. In the feedback circuit 204, the feedback microphone 212 may be coupled to the second filter 214, and the second filter 214 may be coupled to the second gain controller 216. The feedback microphone 212 may correspond to an internal or in-ear microphone of the audio output device 200 that is proximal to the ear canal of the user. The feedback microphone 212, when active, may be configured to detect in-ear sound information (e.g., in-ear noise as described in the foregoing description of FIG. 1) in the ear canal. In an example, the detected in-ear sound information may indicate various characteristics of the in-ear noise. The characteristics may include an amplitude corresponding to a loudness of the in-ear noise, a frequency corresponding to a pitch or tone of the in-ear noise, and a phase indicating a timing or delay of a sound wave of the in-ear noise relative to a reference point. In more examples, the feedback microphone 212 may output the detected in-ear sound information in the form of a voltage signal that carries the amplitude, the frequency, and the phase of the in-ear noise.

The feedback microphone 212 may transmit the detected in-ear sound information to the second filter 214. In an example implementation, an analog to digital converter may be coupled between the feedback microphone 212 and the second filter 214. In such an implementation, the voltage signal outputted by the feedback microphone 212 may be converted to a digital signal by the analog to digital converter before providing to the second filter 214. The second filter 214 may be configured to process and prepare the detected in-ear sound information for noise cancelation. In an example, the first filter 208 may filter signal components corresponding to one or more frequencies from the voltage signal. The second filter 214 may be implemented as a software-based filter using DSP algorithms or as a hardware-based analog filter using various electronic components such as capacitors, resistors, operational amplifiers, or the like. The second filter 214 may transmit the processed in-ear sound information to the second gain controller 216. The second gain controller 216 may be configured to adjust (e.g., increase or decrease) a gain (e.g., the amplitude) of the processed in-ear sound information. For example, the second gain controller 216 may increase or decrease the gain (e.g., the amplitude) of the processed in-ear sound information.

In various aspects, the feed-forward circuit 202 and the feedback circuit 204 may be coupled to the anti-noise generator 224. The anti-noise generator 224 may be configured to receive gain-adjusted versions of the ambient sound information and the in-ear sound information from the feed-forward circuit 202 and the feedback circuit 204, respectively. The anti-noise generator 224 may be configured to add or combine the gain-adjusted versions of the ambient sound information and the in-ear sound information and create a composite signal based on the combination. The composite signal includes information about both the ambient sound information and the in-ear sound information. The anti-noise generator 224 may be configured to generate an anti-noise signal based on the composite signal. As an example, the anti-noise signal may be an inverse waveform that matches the phase and amplitude of the composite signal but is 180 degrees out of phase. In an example, the anti-noise generator 224 may be implemented using at least one of the various types of processing units (e.g., processors), for example, MPUs, MCUs, ASICs, CISC processors, RISC processors, DSPs, FPGAs, or the like.

In various aspects, the ANC circuit 218 may be coupled to the DAC 226. For example, an output of the anti-noise generator 224 may be coupled to the DAC 226. The DAC 226 may be configured to receive the anti-noise signal from the anti-noise generator 224 and convert this anti-noise signal into an analog format for rendering.

In many aspects, the ANC controller 220 may include suitable interfaces, logic, or circuitry configured to determine a mode configuration of the audio output device 200. Examples of various mode configurations may include, but are not limited to, the quiet mode, the non-quiet mode, the transparency mode, or the ANC-disabled mode as described in the foregoing description of FIG. 1. The ANC controller 220 may be configured to determine a mode configuration in which the ANC controller 220 should operate based on various cues, for example, ambient noise levels, user inputs, device usage patterns, battery status of the power supply source 222, or the like. The ANC controller 220 may be configured to control the operation of the feed-forward circuit 202 and the feedback circuit 204 based on the determined mode configuration. For the sake of brevity, the following description covers the operation of the audio output device 200 in the quiet mode and the non-quiet mode.

In an example, the ANC controller 220 may be coupled to the feed-forward circuit 202 and the feedback circuit 204. Upon power up or based on enabling of an ANC feature on the audio output device 200, the ANC controller 220 may be configured to receive ambient sound information from the feed-forward circuit 202 and accordingly determine whether to operate in the non-quiet mode or the quiet mode. For example, if the ambient sound information indicates a noisy environment, the ANC controller 220 may operate the audio output device 200 in the non-quiet mode. Conversely, if the ambient sound information indicates a quiet environment, the ANC controller 220 may operate the audio output device 200 in the quiet mode.

In the non-quiet mode, both the feed-forward circuit 202 and the feedback circuit 204 are enabled for noise detection. In other words, in the non-quiet mode, the feed-forward circuit 202 may continue detecting new ambient sound information and the feedback circuit 204 may continue detecting in-ear sound information. In the quiet mode, the feed-forward circuit 202 is enabled for noise detection and the feedback circuit 204 is disabled. In other words, in the quiet mode, the feed-forward circuit 202 may continue detecting new ambient sound information and the feedback circuit 204 may be inactive.

In various aspects, while the audio output device 200 is operating in the non-quiet mode, if first ambient sound information 228 detected by the feed-forward circuit 202 indicates a quiet environment, the ANC controller 220 may transition from the non-quiet mode to the quiet mode. The ANC controller 220 may disable the feedback circuit 204 based on the transition to the quiet mode. Since the ANC controller 220 does not disable the feed-forward circuit 202, the feed-forward circuit 202 may remain enabled for noise cancelation. Such selective disabling of the feedback circuit 204 in the quiet mode may reduce power consumption of the audio output device 200 and also prevent electrical noise. As a result, the battery life of the audio output device 200 may be extended.

In more aspects, the ANC controller 220 may be configured to suspend a power supply from the power supply source 222 to the feedback circuit 204 to disable the feedback circuit 204. For example, the ANC controller 220 may transmit a control signal to the power supply source 222 to suspend a power supply to the feedback circuit 204. In some examples, based on the control signal, the power supply source 222 may disable one or more components within a power supply path to the feedback circuit 204 to suspend the power supply to the feedback circuit 204. In many examples, the power supply source 222 may use multiplexing techniques or signal level control to dynamically suspend the power supply to the feedback circuit 204. Due to the suspension of the power supply to the feedback circuit 204, power consumption in the audio output device 200 for ANC may be reduced.

In many aspects, when in the quiet mode, the ANC controller 220 may be configured to adjust the gain of the first gain controller 210 based on the detected first ambient sound information 228, without changing the gain of the second gain controller 216. Since the feedback circuit 204 is disabled in the quiet mode, the anti-noise generator 224 only receives a gain-adjusted version of the first ambient sound information 228 from the feed-forward circuit 202 and generates an anti-noise signal that may cancel ambient noise during audio playback, without using in-ear sound information.

Thus, in the quiet mode, the anti-noise signal is an inverse waveform of the gain-adjusted version of the first ambient sound information 228 and is generated without using an output of the feedback circuit 204. In other words, during the quiet mode, the ANC circuit 218 and the ANC controller 220 may apply ANC to an audio signal based on the feed-forward circuit 202 and independent of the feedback circuit 204, and may obtain an active noise-canceled version of the audio signal based on the applied ANC.

In various aspects where the audio output device 200 includes a speaker (for example, the speaker 108), the speaker may render the active noise-canceled version of the audio signal independent of the feedback circuit 204. For example, the speaker may output the anti-noise signal along with a desired audio output, resulting in the active noise-canceled version of the audio signal that preserves the desired audio output. Additionally, by selectively disabling the feedback circuit 204 while keeping the feed-forward circuit 202 active, the power consumption of the audio output device 200 in the quiet mode is reduced without compromising noise cancelation performance of the audio output device 200 in ANC-enabled scenarios.

In many aspects, the transition from the non-quiet mode to the quiet mode may be based on a first similarity index exceeding a threshold value. The first similarity index is between the detected first ambient sound information 228 and at least one sound profile. For example, the audio output device 200 may store (in one or more memories) various sound profiles, such as howling, wind noise, or similar environmental signatures, associated with the quiet mode. These sound profile(s) may represent unique audio signatures that characterize different types of quiet environments where the audio output device 200 can operate in the quiet mode. A sound profile may include various acoustic parameters, such as frequency spectra, amplitude patterns, temporal characteristics, or the like, that define distinctive properties of specific ambient noise scenarios that may be classified as quiet environments. These stored sound profile(s) may allow the ANC controller 220 to identify different quiet environments by analyzing the detected first ambient sound information 228 and comparing the detected first ambient sound information 228 with the sound profile(s). In other words, if the detected first ambient sound information 228 matches any stored sound profile, which characterizes a quiet environment suitable for the quiet mode, beyond the threshold value, (e.g., indicated by the first similarity index), the ANC controller 220 may transition to the quiet mode and disable the feedback circuit 204.

Threshold value may refer to a configured limit or boundary that determines whether ambient sound information sufficiently matches a stored sound profile to trigger mode transition. The threshold value can be expressed as a numerical value that quantifies a degree of similarity between ambient sound information and a sound profile. The threshold value may be a configurable parameter or a setting of the audio output device 200, which may be dynamically adjusted based on user preferences, environmental conditions, or system calibration to ensure accurate mode transitions. The threshold value can correspond to a sensitivity setting of the audio output device 200. Thus, when the threshold value is set to a higher value (e.g., 0.8 or more) on a similarity scale (ranging from 0 to 1), the audio output device 200 may exhibit lower sensitivity, allowing a transition to the quiet mode only when ambient sound information exhibits a near-exact match with a stored sound profile. Conversely, when the threshold value is set to a lower value (e.g., between 0.5-0.7), the audio output device 200 may exhibit higher sensitivity, enabling a transition to the quiet mode even when ambient sound information only partially matches a sound profile. For example, if the threshold value is set at 0.9, the ANC controller 220 may only transition to the quiet mode if the detected first ambient sound information 228 is near-identical to a stored sound profile, such as a quiet office or a silent room. However, with the threshold value set at 0.4, the ANC controller 220 may transition to the quiet mode where the detected first ambient sound information 228 partially matches (e.g., 60% match) a stored sound profile, such as a moderately quiet library or a calm outdoor space with wind noise.

Similarity index may refer to a metric that quantifies how closely ambient sound information matches a stored sound profile. Similarity index may be derived (or determined) by the ANC controller 220 through various pattern-matching techniques, for example, cross-correlation or cosine similarity, which compare various acoustic parameters such as frequency spectra, amplitude variations, or temporal characteristics of the detected ambient sound information against the stored sound profile(s). When the similarity index exceeds the threshold value, the ANC controller 220 may transition to the quiet mode and disable the feedback circuit 204.

In many aspects, the transition from the non-quiet mode to the quiet mode may be based on the detected first ambient sound information 228 being below a sound threshold. For example, the sound threshold may be associated with the quiet mode and may be stored in the one or more memories of the audio output device 200. The sound threshold may represent a maximum allowable sound level where the environment may be considered as quiet enough for the quiet mode to engage. The sound threshold may be measured in, for example, decibels (dB). The sound threshold may be set to a level that distinguishes between background noise and noticeable ambient sound. For example, a sound threshold set around 30-40 dB may indicate a quiet indoor environment, such as a library or a silent room, where activating the quiet mode may be appropriate. Thus, when an amplitude of the detected first ambient sound information 228 is below the sound threshold, the ANC controller 220 may transition to the quiet mode and disable the feedback circuit 204.

While in the quiet mode, the feed-forward circuit 202, which is active, may continue detecting new ambient sound information. For example, the feed-forward circuit 202 may detect second ambient sound information 230 while in the quiet mode. In many aspects, the ANC controller 220 can either transition from the quiet mode to the non-quiet mode or maintain the quiet mode based on the second ambient sound information 230. In various aspects, if the ANC controller 220 transitions to the non-quiet mode, the ANC controller 220 may be configured to enable the feedback circuit 204. For example, to enable the feedback circuit 204, the ANC controller 220 may be configured to resume the power supply from the power supply source 222 to the feedback circuit 204. However, if the ANC controller 220 maintains the quiet mode, the feedback circuit 204 may remain disabled.

In an example scenario, the ANC controller 220 may transition from the quiet mode to the non-quiet mode based on a second similarity index being below the threshold value. The second similarity index is between the detected second ambient sound information 230 and each of the sound profile(s). In more example scenarios, the ANC controller 220 may transition from the quiet mode to the non-quiet mode based on the detected second ambient sound information 230 exceeding the sound threshold.

In additional example scenarios, if the second similarity index exceeds the threshold value, the ANC controller 220 may maintain the quiet mode. The second similarity index is between the detected second ambient sound information 230 and at least one sound profile. In several examples, if the detected second ambient sound information 230 is below the sound threshold, the ANC controller 220 may maintain the quiet mode.

In any ANC-enabled mode configuration (e.g., the non-quiet mode or the quiet mode), the ANC controller 220 may encounter brief conditions that suggest mode transition, such as a sudden spike in ambient noise, a sudden temporary drop in ambient noise, a temporary match with a stored sound profile, or the like. However, these conditions may be short-lived and not indicative of a sustained change in the ambient noise levels. Frequent mode transitions in response to such transient conditions may degrade the stability of the audio output device 200 and user experience. To mitigate this, in various aspects, the ANC controller 220 may implement a hysteresis control mechanism in the audio output device 200 and introduce a buffer period or delay, ensuring that mode transitions only occur when the detected condition persists for at least a configured time-period, thereby preventing unnecessary and frequent mode transitioning and further reducing power consumption. In more examples, the hysteresis control mechanism may be implemented by configuring the sound threshold as a range instead of a singular value.

Based on the implementation of the hysteresis control mechanism, in many examples, the ANC controller 220 may transition from the non-quiet mode to the quiet mode based on the detected first ambient sound information 228 being below the sound threshold for at least the configured time-period. In many examples, the ANC controller 220 may transition from the non-quiet mode to the quiet mode based on the first similarity index exceeding the threshold value for at least the configured time-period. The first similarity index is between the detected first ambient sound information 228 and the at least one sound profile. Likewise, in several examples, the ANC controller 220 may transition to the non-quiet mode from the quiet mode based on the detected second ambient sound information 230 exceeding the sound threshold for the configured time-period.

In numerous aspects, the audio output device 200 may include one or more processors (e.g., the anti-noise generator 224, the ANC controller 220, or the like) which are individually or collectively configured to perform various aspects and examples described in the foregoing description of FIG. 2.

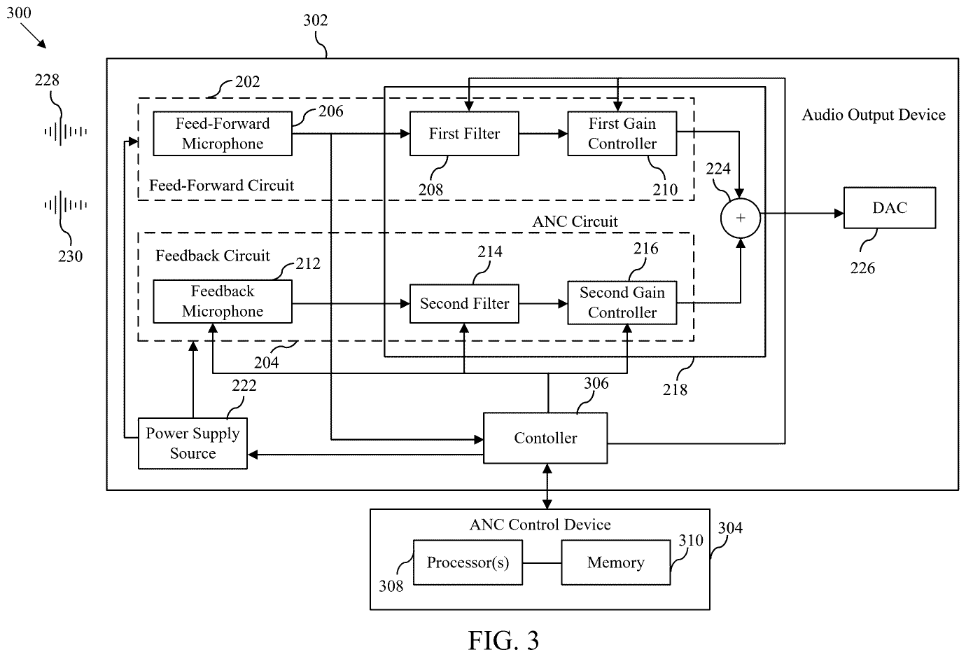

FIG. 3 is a block diagram 300 illustrating an audio output device 302 coupled with an ANC control device 304, in accordance with certain aspects of the present disclosure. FIG. 3 is described in conjunction with FIG. 1 and FIG. 2. The audio output device 302 may be similar to the audio output device 104 shown in FIG. 1 and the audio output device 200 shown in FIG. 2, except that a mode configuration (e.g., the quiet mode and the non-quiet mode) of the audio output device 302 is determined by the ANC control device 304 instead of the audio output device 302.

In many aspects, the audio output device 302 may include the feed-forward circuit 202 and the feedback circuit 204. The feed-forward circuit 202 may include the feed-forward microphone 206, the first filter 208, and the first gain controller 210. The feedback circuit 204 may include the feedback microphone 212, the second filter 214, and the second gain controller 216. The audio output device 302 may include a controller 306, the power supply source 222, the anti-noise generator 224, and the DAC 226. The first filter 208, the first gain controller 210, the second filter 214, the second gain controller 216, and the anti-noise generator 224 may collectively correspond to the ANC circuit 218.

In many aspects, the controller 306 may be similar to the ANC controller 220 except that the mode configuration (e.g., the quiet mode and the non-quiet mode) of the audio output device 302 is determined by the ANC control device 304 instead of the controller 306. In such an embodiment, upon receiving ambient sound information (e.g., the first ambient sound information 228 or the second ambient sound information 230), the controller 306 may transmit the ambient sound information to the ANC control device 304 and receive a mode signal from the ANC control device 304. The mode signal may be indicative of the mode configuration for the audio output device 302. The controller 306 may then operate the audio output device 302 in the determined mode configuration as described in the foregoing description of FIG. 2.

In more aspects, the ANC control device 304 may include one or more processors 308 and one or more memories 310 coupled to the one or more processors 308. In an example, the one or more memories 310 may be configured to store one or more sound profiles associated with the quiet mode and/or the sound threshold as described in the foregoing description of FIG. 2. The one or more memories 310 may also store the plurality of mode configurations, including the quiet mode and the non-quiet mode, of the audio output device 302 as described in the foregoing description of FIG. 2.

In various aspects, the one or more memories 310 may store a set of instructions for managing the audio output device 302, and logic for switching the audio output device 302 between different mode configurations (e.g., the quiet mode and the non-quiet mode). In many aspects, the one or more processors 308 may be configured to determine the mode configuration based on the ambient sound information received from the controller 306 and generate the mode signal indicating the determined mode configuration for operating the audio output device 302. The determination of the mode configuration may be based on the comparison of the ambient sound information with at least one of the stored sound profile(s) or the sound threshold as described in the foregoing description of FIG. 2. The one or more processors 308 may execute the set of instructions stored in the one or more memories 310 for adjusting one or more filter coefficients of the first filter 208 or the second filter 214, or gain values of the first gain controller 210 or the second gain controller 216 based on the ambient sound information received from the controller 306. In an example, the ANC control device 304 can be similar to the UE 116 described in the foregoing description of FIG. 1.

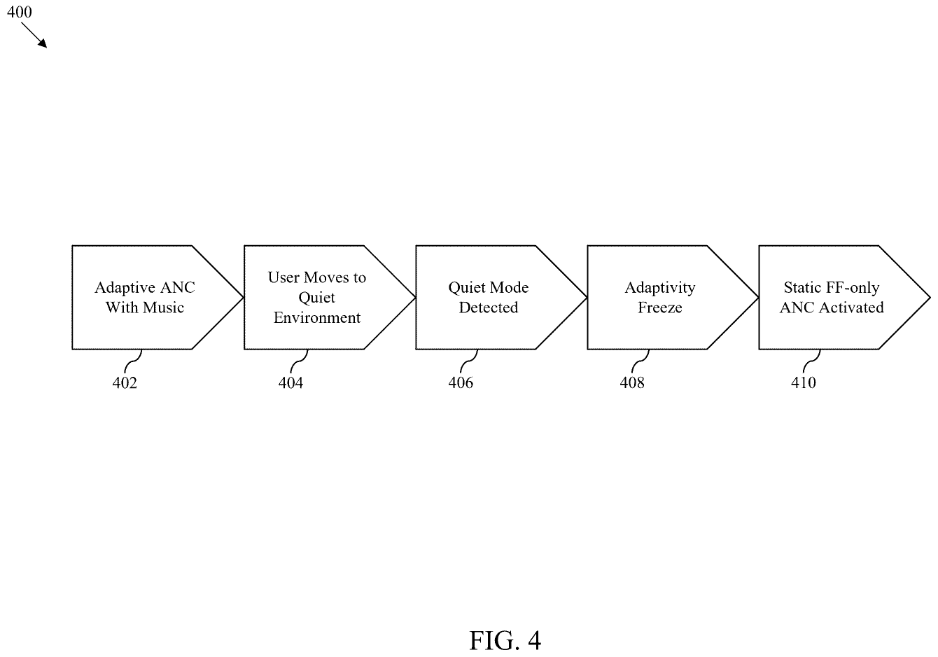

FIG. 4 is a flow diagram that illustrates an example scenario 400 for optimization of an ANC-enabled audio output device, in accordance with certain aspects of the present disclosure. In many examples, the ANC-enabled audio output device can be the audio output device 104, the audio output device 200, or the audio output device 302 described in the foregoing description of FIG. 1-3. FIG. 4 is described in conjunction with FIG. 1-3. The example scenario 400 illustrates various operations 402 through 410 for optimization of the ANC-enabled audio output device. In a non-limiting example, the example scenario 400 is explained with reference to the audio output device 200 of FIG. 2. In various aspects, the audio output device 200 may have a capability to transition between various ANC mode configurations (such as the quiet mode or the non-quiet mode) based on ambient sound conditions.

At 402, the audio output device 104 may be operating in a noisy environment with the non-quiet mode activated. In the non-quiet mode, the ANC controller 220 may apply adaptive ANC for music playback. In other words, both the feed-forward circuit 202 and the feedback circuit 204 may be enabled and gains of the feed-forward circuit 202 and the feedback circuit 204 may be dynamically adjusted based on ambient noise levels.

At 404, the user 102 wearing the audio output device 200 may move from the noisy environment (such as a restaurant) to a quiet environment (such as a library). At 406, the ANC controller 220, which monitors ambient noise through the feed-forward microphone 206, may detect a drop or fall in ambient noise levels. Thus, the ANC controller 220 may detect a quiet mode condition. Quiet mode conditions are described in the foregoing description of FIG. 2. As a result, the ANC controller 220 may transition the audio output device 200 from the non-quiet mode to the quiet mode and disable the entire feedback circuit 204 or only the feedback microphone 212.

At 408, the ANC controller 220 may optionally initiate an adaptivity freeze. The adaptivity freeze may refer to a setting where dynamic gain adjustment of the feed-forward circuit 202 based on changing ambient noise levels is prevented. At 410, based on the disabling of the feedback circuit 204 and the freezing of the adaptivity, static feed-forward-only ANC (e.g., quiet mode with adaptivity freeze for the feed-forward circuit 202) is applied for the music playback on the audio output device 200. Static feed-forward-only ANC may reduce battery consumption of the audio output device 200 in quiet environments.

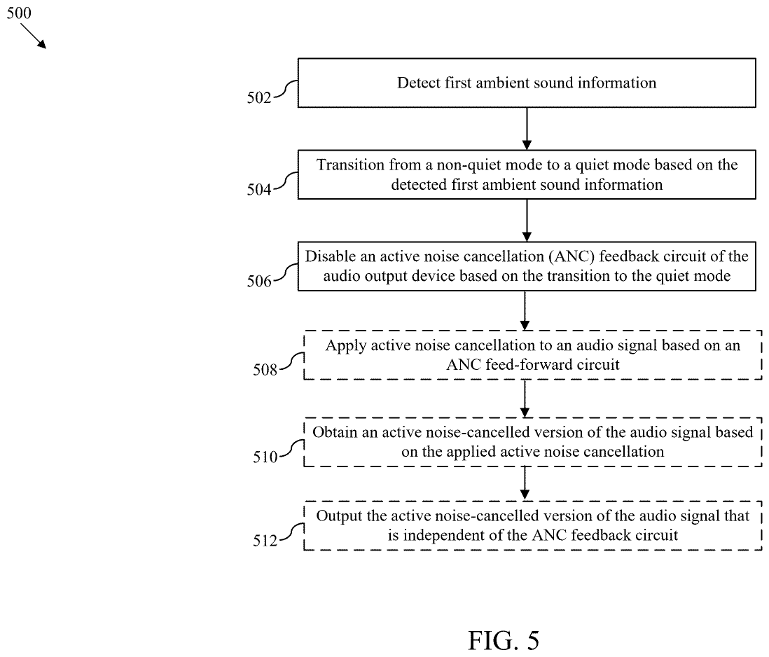

FIG. 5 is a flowchart that illustrates a method (e.g., a process 500) for optimization of an ANC-enabled audio output device, in accordance with certain aspects of the present disclosure. In many examples, the ANC-enabled audio output device can be the audio output device 104, the audio output device 200, or the audio output device 302 described in the foregoing description of FIG. 1-4. FIG. 5 is described in conjunction with FIG. 1-4. Referring to FIG. 5, there is shown a process 500 that illustrates example operations 502 through 512 for optimization of the ANC-enabled audio output device. In a non-limiting example, the process 500 is explained with reference to the audio output device 200 of FIG. 2, which includes the feed-forward circuit 202, the feedback circuit 204, and the ANC controller 220. Additionally, it is assumed that the ANC-enabled audio output device is operating in the non-quiet mode during execution of the example operations.

At 502, first ambient sound information may be detected. For example, the feed-forward circuit 202 may be configured to detect the first ambient sound information 228. In various aspects, the feed-forward circuit 202 may detect the first ambient sound information 228 using one or more external microphones, for example, the feed-forward microphone 206. Such external microphones may be positioned on an outer surface of a housing of the ANC-enabled audio output device to monitor surrounding environment of the ANC-enabled audio output device for external noise.

At 504, the audio output device may be transitioned from the non-quiet mode to the quiet mode based on the detected first ambient sound information. One or more processors of the audio output device may be configured to transition the audio output device from the non-quiet mode to the quiet mode based on the detected first ambient sound information. For example, the ANC controller 220 may transition the audio output device 200 from the non-quiet mode to the quiet mode based on the first ambient sound information 228, which indicates a quiet environment.

At 506, an ANC feedback circuit of the audio output device may be disabled based on the transition to the quiet mode. One or more processors of the audio output device may be configured to disable the ANC feedback circuit of the audio output device based on the transition to the quiet mode. For example, the ANC controller 220 may disable the feedback circuit 204 based on the transition to the quiet mode. The feedback circuit 204, if kept active in quiet environments, may introduce undesirable audio artifacts and consume power without offering a perceivable contribution to ANC. Hence, the disabling of the feedback circuit 204 may result in both power optimization and audio quality improvement.

In an example, quiet surroundings or quiet environment may be defined as an environment where ambient sound levels remain consistently below a configured acoustic threshold or a configured acoustic threshold range, for example, measured in decibels (dB). The thresholds may be static or configurable based on application-specific criteria or user inputs. In more examples, the quiet surroundings or quiet environment may be defined in terms of one or more sound profiles. These sound profile(s) may indicate spectral and temporal profiling of environmental noise that suggests quiet environments such as libraries, private offices, or the like.

At 508, ANC may be applied to an audio signal based on an ANC feed-forward circuit. One or more processors of the audio output device may be configured to apply ANC to the audio signal based on the ANC feed-forward circuit. For example, the ANC controller 220 may apply ANC to the audio signal based on the feed-forward circuit 202. In other words, in the quiet mode, only the feed-forward circuit 202 may be utilized for applying ANC, while the feedback circuit 204 remains inactive. Thus, the optimized ANC-enabled audio output device maintains effective noise suppression while keeping power consumption low. In an example, applying ANC only using the feed-forward circuit 202 may include detecting external noise (such as second ambient sound information, while the audio output device is in the quiet mode) using the feed-forward microphone 206 and providing the detected external noise to one or more components on a feed-forward ANC path such as the first filter 208 and the first gain controller 210. The one or more components on the feed-forward ANC path may generate an anti-noise signal to cancel out the detected external noise.

At 510, based on the applied ANC, an active noise-canceled version of the audio signal is obtained. The one or more processors of the audio output device may be configured to obtain the active noise-canceled version of the audio signal based on the applied ANC. For example, the ANC controller 220 may obtain the active noise-canceled version of the audio signal. In many examples, obtaining the active noise-canceled version of the audio signal may include applying the anti-noise signal to the audio signal, which includes a desired audio output and the detected ambient noise, to cancel out (or suppresses) the detected ambient noise, resulting in an active noise-canceled version of the audio signal that preserves the desired audio output.

At 512, the active noise-canceled version of the audio signal that is independent of the ANC feedback circuit is outputted. The one or more processors of the audio output device may be configured to output the active noise-canceled version of the audio signal. For example, the ANC controller 220 may be configured to cause one or more speakers, such as the speaker 108, to output the active noise-canceled version of the audio signal. Since the feedback circuit 204 is disabled, the active noise-canceled version of the audio signal does not depend on any output of the feedback circuit 204. In other words, the active noise-canceled version of the audio signal is a filtered audio stream in which external noise is suppressed, without using in-ear noise-based feedback correction. As the active noise-canceled version of the audio signal is derived solely from the feed-forward circuit 202, the latency and instability that may arise from overcompensation in low-noise conditions are avoided.

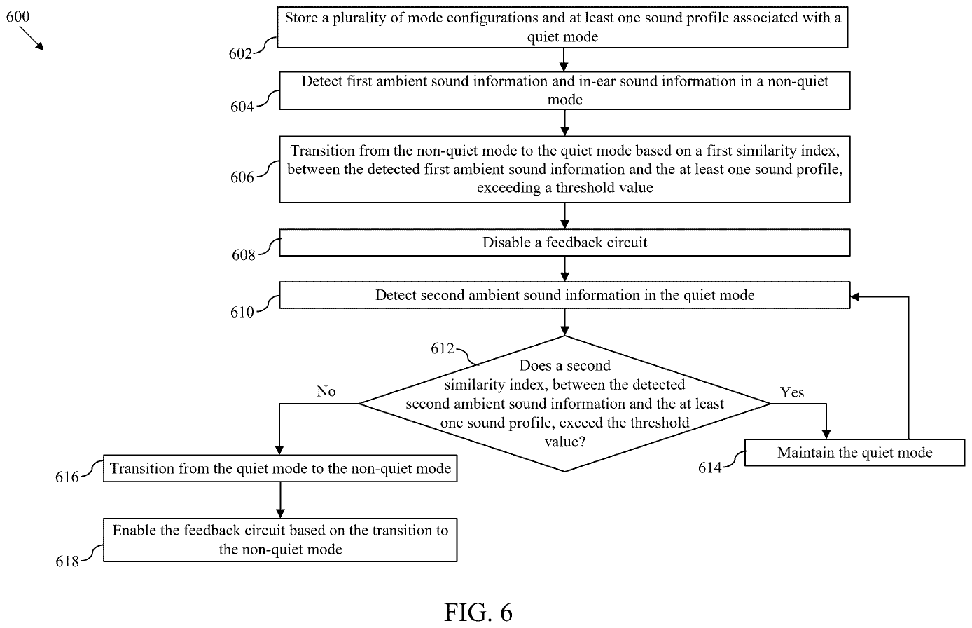

FIG. 6 is a flowchart that illustrates a method (e.g., a process 600) for managing quiet mode and non-quiet mode in an ANC-enabled audio output device based on at least one sound profile, in accordance with certain aspects of the present disclosure. In many examples, the ANC-enabled audio output device can be the audio output device 104, the audio output device 200, or the audio output device 302 described in the foregoing description of FIG. 1-4. FIG. 6 is described in conjunction with FIG. 1-4. Referring to FIG. 6, there is shown a process 600 that illustrates example operations 602 through 616 for managing quiet mode and non-quiet mode in the ANC-enabled audio output device. In a non-limiting example, the process 600 is explained with reference to the audio output device 200 of FIG. 2.

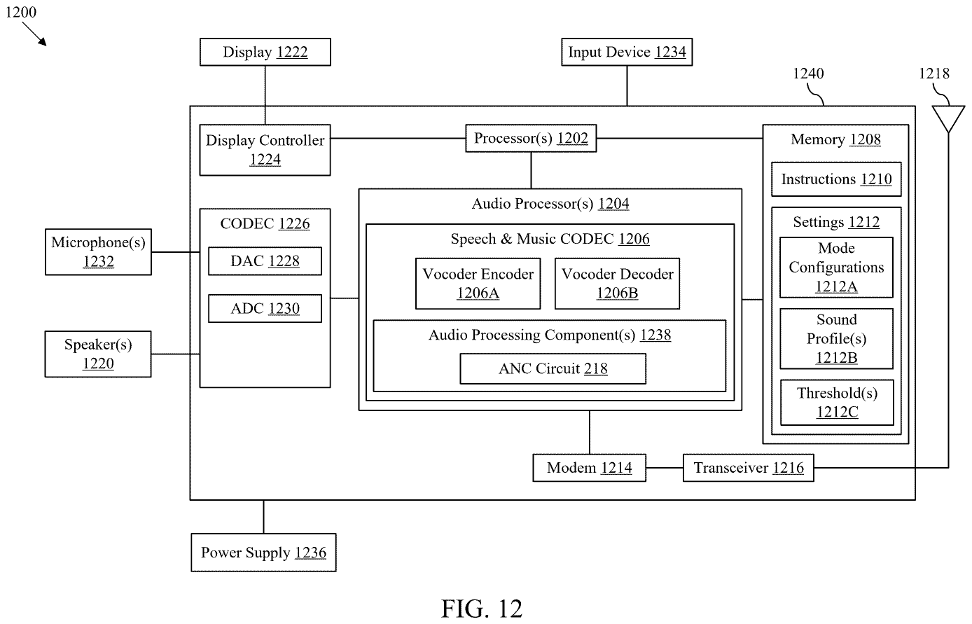

At 602, a plurality of mode configurations and at least one sound profile associated with a quiet mode are stored. For example, one or more memories of the audio output device 200 may be configured to store the plurality of mode configurations and the at least one sound profile associated with the quiet mode as described in the foregoing description of FIG. 2. Examples of the one or more memories of an ANC-enabled audio output device are described later in conjunction with FIG. 12. In an example, the at least one sound profile may serve as a reference pattern representing a quiet environment.

At 604, in the non-quiet mode, first ambient sound information and in-ear sound information may be detected. For example, the feed-forward circuit 202 (e.g., the feed-forward microphone 206) may detect the first ambient sound information 228 and the feedback circuit 204 (e.g., the feedback microphone 212) may detect the in-ear sound information as described in the foregoing description of FIG. 2.

At 606, based on a first similarity index, between the first ambient sound information and the at least one sound profile, exceeding a threshold value, the audio output device may be transitioned from the non-quiet mode to the quiet mode. In an example, one or more processors (e.g., the ANC controller 220) of the audio output device 200 may transition the audio output device 200 from the non-quiet mode to the quiet mode based on a first similarity index, between the first ambient sound information 228 and the at least one sound profile, exceeding the threshold value. The ANC controller 220 may compare the first ambient sound information 228 with the at least one sound profile and determine the first similarity index between the first ambient sound information 228 and the at least one sound profile. If the first similarity index exceeds the threshold value, the ANC controller 220 may transition the audio output device 200 from the non-quiet mode to the quiet mode.

At 608, the feedback circuit may be disabled. For example, the ANC controller 220 may disable the feedback circuit 204 based on the transition to the quiet mode as described in the foregoing description of FIG. 2.

At 610, in the quiet mode, second ambient sound information may be detected. For example, the feed-forward circuit 202 that is still active in the quiet mode may detect the second ambient sound information 230 as described in the foregoing description of FIG. 2.

At 612, it may be determined whether a second similarity index, between the detected second ambient sound information and the stored at least one sound profile, exceeds the threshold value. For example, the ANC controller 220 may compare the second ambient sound information 230 with the at least one sound profile and determine the second similarity index between the second ambient sound information 230 and the at least one sound profile. If at 612, the second similarity index is determined to exceed the threshold value, the control may pass to 614.

At 614, the quiet mode may be maintained. For example, the second similarity index exceeding the threshold value may indicate that the ambient environment surrounding the audio output device 200 is still quiet. Hence, the ANC controller 220 may maintain the audio output device 200 in the quiet mode as described in the foregoing description of FIG. 2. Continued operation of the ANC controller 220 in quiet mode with the feedback circuit 204 disabled, conserves energy.

However, if at 612, the second similarity index is determined to be less than the threshold value, the control may pass to 616. At 616, the audio output device may be transitioned from the quiet mode to the non-quiet mode. For example, the second similarity index being less than the threshold value may indicate a noisy environment. Thus, the ANC controller 220 may transition the audio output device 200 from the quiet mode to the non-quiet mode as described in the foregoing description of FIG. 2.

At 618, the feedback circuit 204 may be enabled based on the transition to the non-quiet mode. For example, one or more processors such as the ANC controller 220 of the audio output device 200 may enable the feedback circuit 204 to allow detection of in-ear sound information for ANC as described in the foregoing description of FIG. 2.

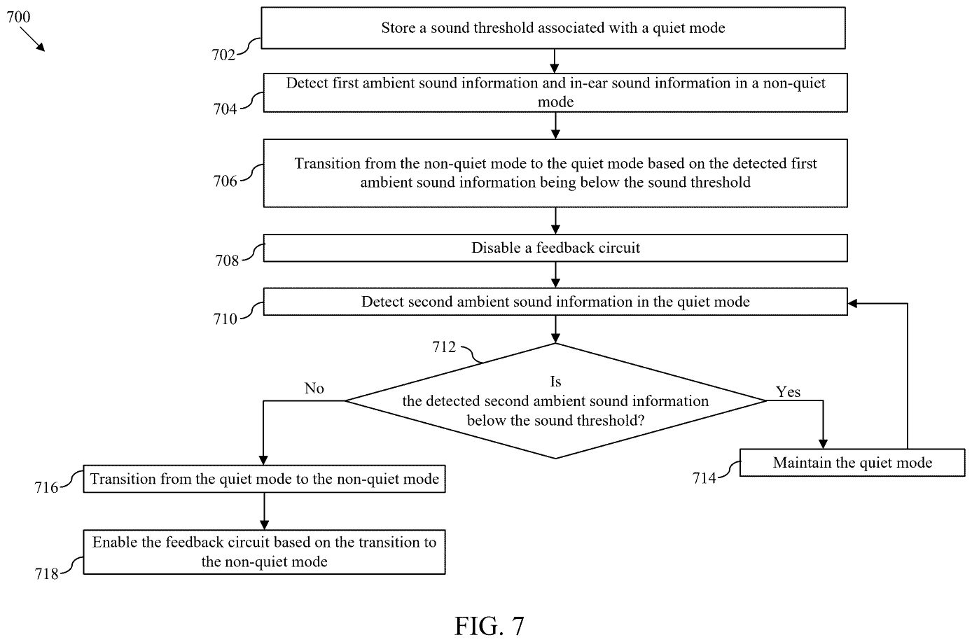

FIG. 7 is a flowchart that illustrates a method (e.g., a process 700) for managing quiet mode and non-quiet mode in an ANC-enabled audio output device based on a sound threshold, in accordance with certain aspects of the present disclosure. In many examples, the ANC-enabled audio output device can be the audio output device 104, the audio output device 200, or the audio output device 302 described in the foregoing description of FIG. 1-6. FIG. 7 is described in conjunction with FIG. 1-4. Referring to FIG. 7, there is shown a process 700 that illustrates example operations 702 through 716 for managing quiet mode and non-quiet mode in the ANC-enabled audio output device. In a non-limiting example, the process 700 is explained with reference to the audio output device 200 of FIG. 2.

At 702, a sound threshold associated with a quiet mode is stored. For example, one or more memories of the audio output device 200 may be configured to store the sound threshold as described in the foregoing description of FIG. 2. Examples of the one or more memories are described later in conjunction with FIG. 12.

At 704, in the non-quiet mode, first ambient sound information and in-ear sound information may be detected. For example, the feed-forward circuit 202 (e.g., the feed-forward microphone 206) may detect the first ambient sound information 228 and the feedback circuit 204 (e.g., the feedback microphone 212) may detect the in-ear sound information as described in the foregoing description of FIG. 2.

At 706, based on the detected first ambient sound information being below the sound threshold, the audio output device may be transitioned from the non-quiet mode to the quiet mode. In an example, one or more processors (e.g., the ANC controller 220) of the audio output device 200 may transition the audio output device 200 from the non-quiet mode to the quiet mode based on the detected first ambient sound information 228 being below the sound threshold. The ANC controller 220 may compare the first ambient sound information 228 with the sound threshold and determine if the first ambient sound information 228 is greater than or less than the sound threshold. If the first ambient sound information 228 is below the sound threshold, the ANC controller 220 may transition the audio output device 200 from the non-quiet mode to the quiet mode as described in the foregoing description of FIG. 2.

At 708, the feedback circuit may be disabled. For example, the ANC controller 220 may disable the feedback circuit 204 based on the transition to the quiet mode as described in the foregoing description of FIG. 2.

At 710, in the quiet mode, second ambient sound information may be detected. For example, the feed-forward circuit 202 that is still active in the quiet mode may detect the second ambient sound information 230 as described in the foregoing description of FIG. 2.

At 712, it may be determined whether the detected second ambient sound information is below the sound threshold. For example, the ANC controller 220 may compare the second ambient sound information 230 with the sound threshold and determine whether the second ambient sound information 230 is below the sound threshold. If at 712, the second ambient sound information 230 is determined to be below the sound threshold, the control may pass to 714.

At 714, the quiet mode may be maintained. For example, the second ambient sound information 230 being below the sound threshold may indicate that the ambient environment surrounding the audio output device 200 is still quiet. Hence, the ANC controller 220 may maintain the audio output device 200 in the quiet mode as described in the foregoing description of FIG. 2.

However, if at 712, the second ambient sound information 230 is determined to be greater than the sound threshold, the control may pass to 716. At 716, the audio output device may be transitioned from the quiet mode to the non-quiet mode. For example, the second ambient sound information 230 being greater than the sound threshold may indicate a noisy environment. Thus, the ANC controller 220 may transition the audio output device 200 from the quiet mode to the non-quiet mode as described in the foregoing description of FIG. 2.

At 718, the feedback circuit 204 may be enabled based on the transition to the non-quiet mode. For example, the ANC controller 220 may enable the feedback circuit 204 to allow the detection of in-ear sound information for ANC as described in the foregoing description of FIG. 2.

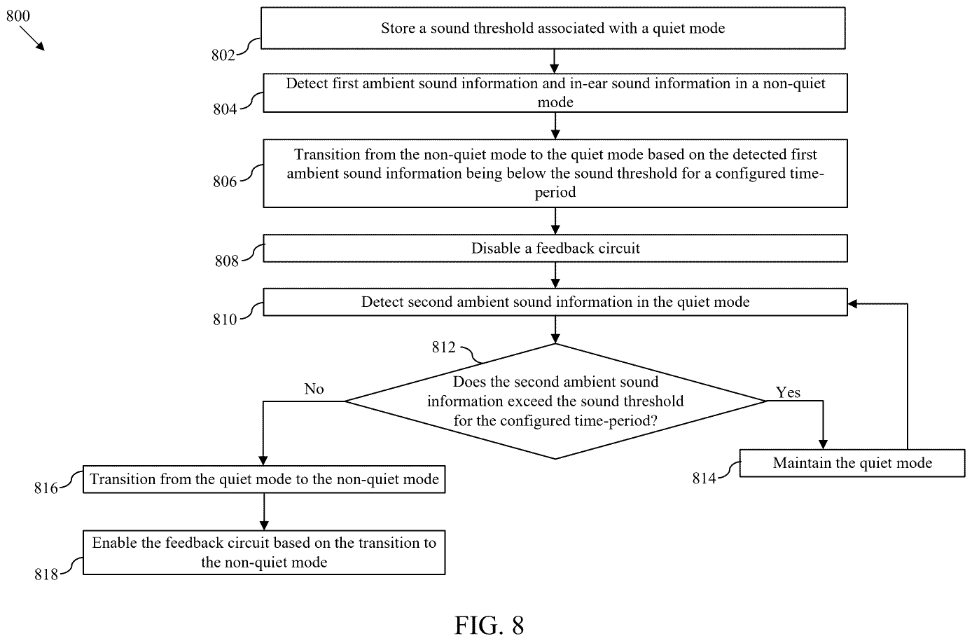

FIG. 8 is a flowchart that illustrates a method (e.g., a process 800) for managing quiet mode and non-quiet mode in an ANC-enabled audio output device based on a sound threshold and a configured time-period, in accordance with certain aspects of the present disclosure. In many examples, the ANC-enabled audio output device can be the audio output device 104, the audio output device 200, or the audio output device 302 described in the foregoing description of FIG. 1-4. FIG. 8 is described in conjunction with FIG. 1-4. Referring to FIG. 8, there is shown a process 800 that illustrates example operations 802 through 816 for managing quiet mode and non-quiet mode in the ANC-enabled audio output device. In a non-limiting example, the process 800 is explained with reference to the audio output device 200 of FIG. 2.

At 802, a sound threshold associated with a quiet mode is stored. For example, one or more memories associated with the audio output device 200 may be configured to store the sound threshold as described in the foregoing description of FIG. 2. Examples of the one or more memories are described later in conjunction with FIG. 12.

At 804, in the non-quiet mode, first ambient sound information and in-ear sound information may be detected. For example, the feed-forward circuit 202 (e.g., the feed-forward microphone 206) may detect the first ambient sound information 228 and the feedback circuit 204 (e.g., the feedback microphone 212) may detect the in-ear sound information as described in the foregoing description of FIG. 2.

At 806, based on the detected first ambient sound information being below the sound threshold for a configured time-period, the audio output device may be transitioned from the non-quiet mode to the quiet mode. In an example, one or more processors (e.g., the ANC controller 220) of the audio output device 200 may transition the audio output device 200 from the non-quiet mode to the quiet mode based on the detected first ambient sound information 228 being below the sound threshold for the configured time-period, such as 1 second, 2 seconds, or the like. The ANC controller 220 may compare the first ambient sound information 228 with the sound threshold and determine if the first ambient sound information 228 is less than the sound threshold for the configured time-period. If the first ambient sound information 228 is below the sound threshold for the configured time-period, the ANC controller 220 may transition the audio output device 200 from the non-quiet mode to the quiet mode as described in the foregoing description of FIG. 2.

At 808, the feedback circuit may be disabled. For example, the ANC controller 220 may disable the feedback circuit 204 based on the transition to the quiet mode as described in the foregoing description of FIG. 2.

At 810, in the quiet mode, second ambient sound information may be detected. For example, the feed-forward circuit 202 that is still active in the quiet mode may detect the second ambient sound information 230 as described in the foregoing description of FIG. 2.

At 812, it may be determined whether the detected second ambient sound information exceeds the sound threshold for the configured time-period. For example, the ANC controller 220 may compare the second ambient sound information 230 with the sound threshold and determine whether the second ambient sound information 230 exceeds the sound threshold for the configured time-period. If at 812, the second ambient sound information 230 is determined to not exceed the sound threshold for more than the configured time-period, the control may pass to 814.

At 814, the quiet mode may be maintained. For example, the second ambient sound information 230 being below the sound threshold may indicate that the ambient environment surrounding the audio output device 200 is still quiet. Hence, the ANC controller 220 may maintain the audio output device 200 in the quiet mode as described in the foregoing description of FIG. 2.

However, if at 812, the second ambient sound information 230 is determined to be greater than the sound threshold for more than the configured time-period, the control may pass to 816. At 816, the audio output device may be transitioned from the quiet mode to the non-quiet mode. For example, the second ambient sound information 230 being greater than the sound threshold for more than the configured time-period may indicate a noisy environment. Thus, the ANC controller 220 may transition the audio output device 200 from the quiet mode to the non-quiet mode as described in the foregoing description of FIG. 2.

At 818, the feedback circuit 204 may be enabled based on the transition to the non-quiet mode. For example, one or more processors such as the ANC controller 220 of the audio output device 200 may enable the feedback circuit 204 to allow detection of in-ear sound information for ANC as described in the foregoing description of FIG. 2.

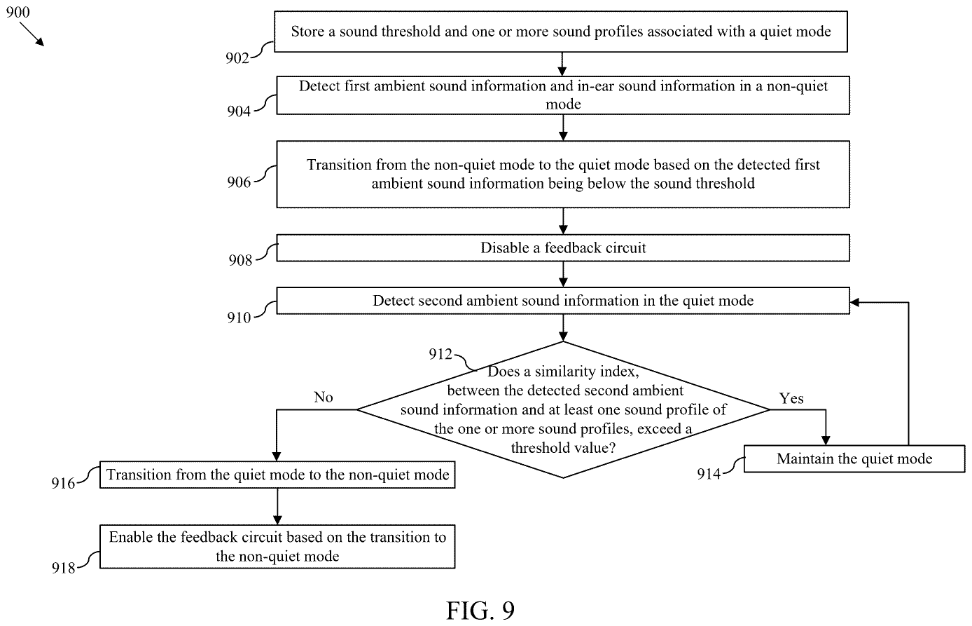

FIG. 9 is a flowchart that illustrates a method (e.g., a process 900) for managing quiet mode and non-quiet mode in an ANC-enabled audio output device based on a sound threshold and one or more sound profiles, in accordance with certain aspects of the present disclosure. In many examples, the ANC-enabled audio output device can be the audio output device 104, the audio output device 200, or the audio output device 302 described in the foregoing description of FIG. 1-4. FIG. 9 is described in conjunction with FIG. 1-4. Referring to FIG. 9, there is shown a process 900 that illustrates example operations 902 through 916 for managing a quiet mode and a non-quiet mode in the ANC-enabled audio output device. In a non-limiting example, the process 900 is explained with reference to the audio output device 200 of FIG. 2.

At 902, a sound threshold and one or more sound profiles associated with a quiet mode are stored. For example, one or more memories associated with the audio output device 200 may be configured to store the sound threshold and the one or more sound profiles associated with the quiet mode as described in the foregoing description of FIG. 2. Examples of the one or more memories are described later in conjunction with FIG. 12. In an example, the one or more sound profiles may serve as reference patterns representing different types of quiet environment (e.g., a library, a private office, or the like).

At 904, in the non-quiet mode, first ambient sound information and in-ear sound information may be detected. For example, the feed-forward circuit 202 (e.g., the feed-forward microphone 206) may detect the first ambient sound information 228 and the feedback circuit 204 (e.g., the feedback microphone 212) may detect the in-ear sound information as described in the foregoing description of FIG. 2.

At 906, based on the detected first ambient sound information being below the sound threshold, the audio output device may be transitioned from the non-quiet mode to the quiet mode. For example, one or more processors (e.g., the ANC controller 220) of the audio output device 200 may transition the audio output device 200 from the non-quiet mode to the quiet mode based on the detected first ambient sound information being below the sound threshold as described in the foregoing description of FIG. 2. At 908, the feedback circuit may be disabled. For example, the ANC controller 220 may disable the feedback circuit 204 based on the transition to the quiet mode as described in the foregoing description of FIG. 2.

At 910, in the quiet mode, second ambient sound information may be detected. For example, the feed-forward circuit 202 that is still active in the quiet mode may detect the second ambient sound information 230 as described in the foregoing description of FIG. 2.

At 912, it may be determined whether a similarity index, between the detected second ambient sound information and at least one sound profile, exceeds a threshold value. For example, the ANC controller 220 may compare the second ambient sound information 230 with the one or more sound profiles and determine similarity indices between the second ambient sound information 230 and the one or more sound profiles. If at 912, the similarity index between the second ambient sound information 230 and at least one sound profile of the one or more sound profiles exceeds the threshold value, the control may pass to 914.

At 914, the quiet mode may be maintained. For example, the similarity index exceeding the threshold value may indicate that ambient environment surrounding the audio output device 200 is still quiet. Hence, the ANC controller 220 may maintain the audio output device 200 in the quiet mode based on the similarity index, between the detected second ambient sound information 230 and the at least one sound profile, exceeding the threshold value as described in the foregoing description of FIG. 2.

However, if at 912, the similarity indices between the second ambient sound information 230 and each of the one or more sound profiles are determined to be less than the threshold value, the control may pass to 716. At 716 the audio output device may be transitioned from the quiet mode to the non-quiet mode. For example, the similarity indices between the second ambient sound information 230 and each of the one or more sound profiles being less than the threshold value may indicate a noisy environment. Thus, the ANC controller 220 may transition the audio output device 200 from the quiet mode to the non-quiet mode based on the similarity indices between the second ambient sound information 230 and each of the one or more sound profiles being less than the threshold value as described in the foregoing description of FIG. 2.

At 918, the feedback circuit 204 may be enabled based on the transition to the non-quiet mode. For example, one or more processors such as the ANC controller 220 may enable the feedback circuit 204 to allow detection of in-ear sound information for ANC as described in the foregoing description of FIG. 2.

In many additional aspects, a decision to transition from the non-quiet mode to the quiet mode may be based on a comparison between the first ambient sound information 228 and the one or more sound profiles, and a decision on whether to transition from the quiet mode to the non-quiet mode or maintain the quiet mode may be based on a comparison between the second ambient sound information 230 and the sound threshold.

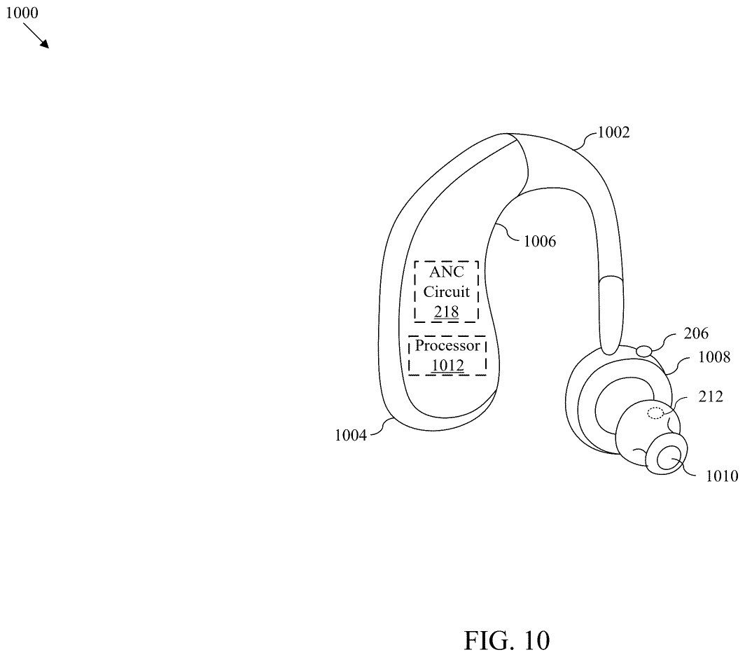

FIG. 10 is a diagram that illustrates an example implementation 1000 of a wearable device 1002 configured to perform optimized ANC, in accordance with certain aspects of the present disclosure. FIG. 10 is described in conjunction with FIG. 1-9. The wearable device 1002 may be similar to the audio output device 104 shown in FIG. 1, the audio output device 200 shown in FIG. 2, or the audio output device 302 shown in FIG. 3. Referring to FIG. 10, the wearable device 1002 is a hearing aid device that may perform optimized ANC as described in the foregoing description of FIG. 1-9.

In the example illustrated in FIG. 10, the wearable device 1002 includes a portion 1004 configured to be worn behind an ear of a user, a portion 1006 configured to extend over the ear, and a portion 1008 to be worn at or near an ear canal of the user. In other examples, the wearable device 1002 may have a different configuration. To illustrate, the wearable device 1002 can be an in-ear device that does not include the portion 1004 and the portion 1006.

In the example implementation 1000, the wearable device 1002 is shown to include an external microphone (e.g., the feed-forward microphone 206, also referred to as out-ear microphone), a speaker 1010, an internal microphone (e.g., the feedback microphone 212, also referred to as in-ear microphone), and one or more audio processing components such as the ANC circuit 218 and a processor 1012. In an example, the processor 1012 may be similar to the controller 114 of FIG. 1, the ANC controller 220 of FIG. 2, or the controller 306.

In a particular example of operation of the wearable device 1002, the feed-forward microphone 206 may be configured to detect ambient sound information (such as the first ambient sound information 228 or the second ambient sound information 230 of FIG. 2). Based on the detected ambient sound information, the processor 1012 may determine a mode configuration for operating the ANC circuit 218. For example, based on the detected ambient sound information, the processor 1012 may determine whether to operate in the non-quiet mode or the quiet mode. Additionally, the processor 1012 may determine whether to maintain the current mode configuration or transition to a different mode configuration based on the detected ambient sound information as described in the forgoing description of FIG. 1-9. In an example, the wearable device 1002 may be operating in the non-quiet mode. In such an example, based on the detected ambient sound information, the processor 1012 may determine whether to maintain the non-quiet mode or transition to the quiet mode. In additional examples, the wearable device 1002 may be operating in the quiet mode. In such an example, based on the detected ambient sound information, the processor 1012 may determine whether to maintain the quiet mode or transition to the non-quiet mode. In the quiet mode, the processor 1012 may disable the feedback microphone 212 to reduce power consumption without compromising the ANC performance of the wearable device 1002.

In various aspects, the speaker 1010 may output an active noise-canceled version of an audio signal. In an example, when the wearable device 1002 is operating in the non-quiet mode, the active noise-canceled version of the audio signal may be based on detection outputs of both the feed-forward microphone 206 and the feedback microphone 212. However, in the quiet mode, the active noise-canceled version of the audio signal may be based on a detection output of the feed-forward microphone 206 and independent of the feedback microphone 212.

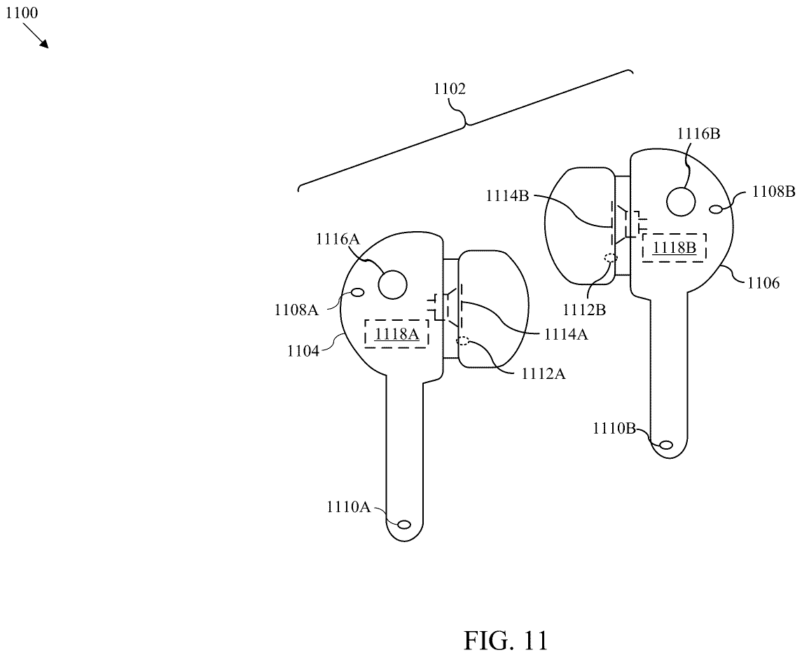

FIG. 11 is a diagram that illustrates an example implementation 1100 of a portable electronic device 1102 configured to perform optimized ANC, in accordance with certain aspects of the present disclosure. FIG. 11 is described in conjunction with FIG. 1-9. Referring to FIG. 11, the portable electronic device 1102 may include one or more earbuds, for example, a first earbud 1104 and a second earbud 1106. Each of the first earbud 1104 and the second earbud 1106 may be similar to the audio output device 104 shown in FIG. 1, the audio output device 200 shown in FIG. 2, or the audio output device 302 shown in FIG. 3. Although the first earbud 1104 and the second earbud 1106 are described in FIG. 11, it should be understood that the scope of the disclosure may be applied to other in-ear or over-ear audio devices.

In the example illustrated in FIG. 11, the first earbud 1104 includes first and second external microphones 1108A and 1110A to detect ambient sound information. The first and second external microphones 1108A and 1110A can be similar to the external microphone 110 of FIG. 1 or the feed-forward microphone 206 of FIG. 2. The first earbud 1104 also includes an internal microphone 1112A proximate to the wearer's ear canal (e.g., to assist with active noise canceling. The internal microphone 1112A can be similar to the internal microphone 106 of FIG. 1 or the feedback microphone 212 of FIG. 2. The first earbud 1104 may also include a speaker 1114A, for example, similar to the speaker 108 of FIG. 1. The first earbud 1104 may also include ANC circuit 1116A and one or more processors 1118A. In an example, the ANC circuit 1116A can be similar to the ANC circuit 112 of FIG. 1 or the ANC circuit 218 of FIGS. 2 and 3, and the one or more processors 1118A may include the controller 114 of FIG. 1, the ANC controller 220 of FIG. 2, or the controller 306 of FIG. 3.

The second earbud 1106 can be configured in a substantially similar manner to the first earbud 1104. For example, the second earbud 1106 can include third and fourth external microphones 1108B and 1110B, an internal microphone 1112B, a speaker 1114B, an ANC circuit 1116B, and one or more processors 1118B.

In some aspects, the first and second earbuds 1104, 1106 may be configured to automatically switch between various mode configurations, such as the non-quiet mode in which both external and internal microphones are enabled and the quiet mode in which only external microphones are enabled, for ANC.

In various aspects, if the first earbud 1104 in a dual-earbud setup is associated with a transition to the quiet mode, the one or more processors 1118A individually or collectively may be configured to control the second earbud 1106 to also transition to the quiet mode. For example, if the first earbud 1104 is transitioned to the quiet mode, the one or more processors 1118A may provide a mode switch signal to the one or more processors 1118B, which may cause the second earbud 1106 to also transition to the quiet mode. Thus, power is conserved in the first earbud 1104 and the second earbud 1106 when ANC is applied in quiet environments.

FIG. 12 is a block diagram of an example implementation of a device 1200, in accordance with certain aspects of the present disclosure. In various aspects, the device 1200 may have more or fewer components than illustrated in FIG. 12. In an example implementation, the device 1200 may correspond to any of the audio output devices 104, 200, 302, the wearable device 1002, the first or second earbuds 1104 and 1106. In an illustrative implementation, the device 1200 may perform one or more operations described with reference to FIG. 1-11.

In many aspects, the device 1200 may include a processor 1202 (e.g., a central processing unit “CPU”). The device 1200 may include one or more additional processors, for example, audio processor(s) 1204. In an example, the controller 114 of FIG. 1, the ANC controller 220 and the anti-noise generator 224 of FIG. 2, the controller 306 of FIG. 3, the processor 1012, the processors 1118A and 1118B can correspond to the processor 1202, the audio processor(s) 1204, or a combination thereof. The audio processor(s) 1204 may include a speech and music coder-decoder (CODEC) 1206 that includes a voice coder (“vocoder”) encoder 1206A and a vocoder decoder 1206B. The audio processor(s) 1204 and/or the speech and music CODEC 1206 may include one or more audio processing component(s) 1238, such as the ANC circuit 218 as described in FIG. 2. Optionally, the audio processing component(s) 1238 can include other components as described above with reference to FIG. 1-11.

In FIG. 12, the device 1200 may include a memory 1208 and a CODEC 1226. The memory 1208 may include (e.g., stores) instructions 1210 that are executable by the one or more audio processors 1204 (or the processor 1202) to implement the functionality described with reference to the audio output device 104 of FIG. 1, the audio output device 200 of FIG. 2, or the audio output device 302 of FIG. 3. The memory 1208 may also store settings 1212, which indicate various mode configurations 1212A (e.g., the non-quiet mode and the quiet mode), various sound profiles 1212B, and one or more thresholds 1212C (e.g., the sound threshold and the threshold value for similarity index comparison) to implement the functionality described with reference to the audio output device 104 of FIG. 1, the audio output device 200 of FIG. 2, or the audio output device 302 of FIG. 3.

In FIG. 12, the device 1200 may also include a modem 1214 coupled, via a transceiver 1216, to an antenna 1218. The modem 1214, the transceiver 1216, and the antenna 1218 may enable the device 1200 to exchange data with one or more other devices via wireless communications. For example, in some implementations, the device 1200 may generate an active noise-canceled audio output at speaker(s) 1220 based on data received via wireless communication with another device (e.g., the UE 116 of FIG. 1).

The device 1200 may include a display 1222 coupled to a display controller 1224. The speaker(s) 1220 and microphone(s) 1232 may be coupled to the CODEC 1226. In an example, the microphone(s) 1232 may include feed-forward microphones and feedback microphones used in ANC as described in the foregoing description of FIGS. 1-11. In FIG. 12, the CODEC 1226 may include a DAC 1228 and an analog-to-digital converter (ADC) 1230. In an example, the CODEC 1226 may receive analog signals (e.g., out-ear noise and optionally in-ear noise) from the microphone(s) 1232, convert the analog signals to digital signals using the ADC 1230, and provide the digital signals to the speech and music CODEC 1206 for applying ANC. The speech and music CODEC 1206 may process the digital signals. The digital signals may be processed by the audio processing components 1238. For example, the ANC circuit 218 of the audio processing components 1238 may process the digital signals to generate an anti-noise signal for suppressing noise in a desired audio output as described in the foregoing description of FIG. 1-11.

In an example, the speech and music CODEC 1206 may provide the anti-noise signal and the desired audio output (in a digital format) to the CODEC 1226. The CODEC 1226 may convert the digital signals to analog signals using the DAC 1228 and may provide the analog signals to the speaker(s) 1220 for outputting. In such an example, the speakers 1220 may thus output the anti-noise signal and the desired audio output. The anti-noise signal cancels out (or suppresses) noise, resulting in the active noise-canceled version of the audio signal that preserves the desired audio output.

In an example implementation, the device 1200 may be included in a system-in-package or system-on-chip device 1240. For example, the memory 1208, the processor 1202, the audio processor(s) 1204, the display controller 1224, the CODEC 1226, the modem 1214, and the transceiver 1216 may be included in the system-in-package or system-on-chip device 1240.

In various aspects, an input device 1234 and a power supply 1236 may be coupled to the system-in-package or the system-on-chip device 1240. Moreover, in an example implementation, as illustrated in FIG. 12, the display 1222, the input device 1234, the speaker(s) 1220, the microphone(s) 1232, the antenna 1218, and the power supply 1236 may be external to the system-in-package or the system-on-chip device 1240. Each of the display 1222, the input device 1234, the speaker(s) 1220, the microphone(s) 1232, the antenna 1218, and the power supply 1236 may be coupled to a component of the system-in-package or the system-on-chip device 1240 such as an interface or a controller.

The device 1200 may include a wearable device, such as a wearable mobile communication device, a wearable personal digital assistant, a wearable gaming system, a wearable music player, a wearable radio, a wearable navigation device, a headset, an augmented reality headset, a mixed reality headset, a virtual reality headset, a voice-activated device, a portable electronic device, a wearable computing device, a wearable communication device, a virtual reality (VR) device, one or more earbuds, a hearing aid device, or any combination thereof.

In conjunction with the described implementations, an apparatus includes means for managing a quiet mode and a non-quiet mode (e.g., an ANC-enabled audio output device) based on ambient sound information as described in the foregoing description of FIG. 1-11. For example, the means for managing the quiet mode and the non-quiet mode can correspond to the audio output device 104, the audio output device 200, the ANC controller 220, the audio output device 302, the ANC control device 304, the processor(s) 308, the processor 1202, the audio processor(s) 1204, or any combination thereof.

In many implementations, a non-transitory computer-readable medium (e.g., a computer-readable storage device, such as the memory 1208) includes instructions (e.g., the instructions 1210) that, when executed by one or more processors (e.g., the 1202 or the audio processor(s) 1204), cause the one or more processors to manage a quiet mode and a non-quiet mode based on ambient sound information as described in the foregoing description of FIG. 1-11.

Some implementation examples are described in the following numbered aspects:

Aspect 1: A method for active noise cancelation (ANC), the method comprising detecting first ambient sound information by a feed-forward circuit and detecting in-ear sound information by a feedback circuit. The method comprising storing a plurality of mode configurations comprising a quiet mode and a non-quiet mode. The method comprising transitioning from a non-quiet mode to a quiet mode based on the detected first ambient sound information and disabling the feedback circuit based on the transition to the quiet mode.

Aspect 2: The method of aspect 1, comprising storing at least one sound profile associated with the quiet mode.

Aspect 3: The method of aspect 2, comprising transitioning from the non-quiet mode to the quiet mode based on a similarity index, between the detected first ambient sound information and the at least one sound profile, exceeding a threshold value.

Aspect 4: The method of any of aspects 2 through 3, comprising detecting second ambient sound information in the quiet mode by the feed-forward circuit. The method comprising maintaining the quiet mode based on a similarity index, between the detected second ambient sound information and the at least one sound profile, exceeding a threshold value.

Aspect 5: The method of any of aspects 2 or 4, comprising detecting second ambient sound information in the quiet mode by the feed-forward circuit. The method comprising transitioning from the quiet mode to the non-quiet mode based on a similarity index, between the detected second ambient sound information and the at least one sound profile, being below a threshold value and enabling the feedback circuit based on the transition to the non-quiet mode.

Aspect 6: The method of aspect 1, comprising storing a sound threshold associated with the quiet mode. The method comprising transitioning from the non-quiet mode to the quiet mode based on the detected first ambient sound information being below the sound threshold.

Aspect 7: The method of aspect 6, comprising transitioning from the non-quiet mode to the quiet mode based on the detected first ambient sound information being below the sound threshold for at least a configured time-period.

Aspect 8: The method of aspect 6, comprising detecting second ambient sound information in the quiet mode. The method comprising maintaining the quiet mode based on the detected second ambient sound information being below the sound threshold.

Aspect 9: The method of aspect 8, comprising transitioning to the non-quiet mode from the quiet mode based on the detected second ambient sound information exceeding the sound threshold for a configured time-period, and enabling the feedback circuit based on the transition to the non-quiet mode.

Aspect 10: The method of aspect 6, comprising storing one or more sound profiles associated with the quiet mode.

Aspect 11: The method of aspect 10, comprising to detecting second ambient sound information in the quiet mode. The method comprising maintaining the quiet mode based on a similarity index, between the detected second ambient sound information and at least one sound profile of the one or more sound profiles, exceeding a threshold value.

Aspect 12: The method of aspect 10, detecting second ambient sound information in the quiet mode. The method comprising transitioning to the non-quiet mode from the quiet mode based on a similarity index between the detected second ambient sound information and each of the one or more sound profiles being below a threshold value and enabling the feedback circuit based on the transition to the non-quiet mode.

Aspect 13: The method of any of aspects 1 through 12, comprising suspending a power supply from a power supply source to the feedback circuit to disable the feedback circuit.

Aspect 14: The method of any of aspects 1 through 13, wherein in a case where the audio output device corresponds to a first earbud, in a dual-earbud setup, that is associated with the transition to the quiet mode, the method comprising controlling a second earbud in the dual-earbud setup to transition to the quiet mode.

Aspect 15: The method of any of aspects 1 through 14, comprising detecting the in-ear sound information in the non-quiet mode by using a feedback microphone of the feedback circuit, the feedback circuit comprising the feedback microphone and at least one of a filter or a gain controller.

Aspect 16: The method of any of aspects 1 through 15, comprising detecting the first ambient sound information by using a feed-forward microphone of the feed-forward circuit, the feed-forward circuit comprising the feed-forward microphone and at least one of a filter or a gain controller.

Aspect 17: The method of aspect 16, comprising adjusting a gain of the gain controller based on the detected first ambient sound information in the quiet mode in a case where the feed-forward circuit comprises the gain controller.

Aspect 18: The method of any of aspects 1 through 17, comprising applying, in the quiet mode, active noise cancelation to an audio signal based on the feed-forward circuit and independent of the feedback circuit, and obtaining an active noise-canceled version of the audio signal based on the applied active noise cancelation.

Aspect 19: The method of any of aspects 1 through 18, comprising outputting an active noise-canceled version of an audio signal independent of the feedback circuit, using a speaker.

Aspect 20: A method for active noise cancelation (ANC), the method comprising detecting first ambient sound information by an out-ear microphone and detecting in-ear sound information by an in-ear microphone. The method comprising storing a plurality of mode configurations comprising a quiet mode and a non-quiet mode. The method comprising transitioning from a non-quiet mode to a quiet mode based on the detected first ambient sound information and disabling the in-ear microphone based on the transition to the quiet mode.

Aspect 21: The method of aspect 20, comprising storing at least one sound profile associated with the quiet mode.

Aspect 22: The method of aspect 21, comprising transitioning from the non-quiet mode to the quiet mode based on a similarity index, between the detected first ambient sound information and the at least one sound profile, exceeding a threshold value.

Aspect 23: The method of any of aspects 21 through 23, comprising detecting second ambient sound information in the quiet mode by the out-ear microphone. The method comprising maintaining the quiet mode based on a similarity index, between the detected second ambient sound information and the at least one sound profile, exceeding a threshold value.

Aspect 24: The method of any of aspects 21 or 24, comprising detecting second ambient sound information in the quiet mode by the out-ear microphone. The method comprising transitioning from the quiet mode to the non-quiet mode based on a similarity index, between the detected second ambient sound information and the at least one sound profile, being below a threshold value and enabling the in-ear microphone based on the transition to the non-quiet mode.

Aspect 25: The method of aspect 20, comprising storing a sound threshold associated with the quiet mode. The method comprising transitioning from the non-quiet mode to the quiet mode based on the detected first ambient sound information being below the sound threshold.

Aspect 26: The method of aspect 25, comprising transitioning from the non-quiet mode to the quiet mode based on the detected first ambient sound information being below the sound threshold for at least a configured time-period.

Aspect 27: The method of aspect 25, comprising detecting second ambient sound information in the quiet mode. The method comprising maintaining the quiet mode based on the detected second ambient sound information being below the sound threshold.

Aspect 28: The method of aspect 27, comprising transitioning to the non-quiet mode from the quiet mode based on the detected second ambient sound information exceeding the sound threshold for a configured time-period, and enabling the in-ear microphone based on the transition to the non-quiet mode.

Aspect 29: The method of aspect 25, comprising storing one or more sound profiles associated with the quiet mode.

Aspect 30: The method of aspect 29, comprising to detecting second ambient sound information in the quiet mode. The method comprising maintaining the quiet mode based on a similarity index, between the detected second ambient sound information and at least one sound profile of the one or more sound profiles, exceeding a threshold value.

Aspect 31: The method of aspect 29, detecting second ambient sound information in the quiet mode. The method comprising transitioning to the non-quiet mode from the quiet mode based on a similarity index between the detected second ambient sound information and each of the one or more sound profiles being below a threshold value and enabling the in-ear microphone circuit based on the transition to the non-quiet mode.

Aspect 32: The method of any of aspects 20 through 31, comprising suspending a power supply from a power supply source to the in-ear microphone to disable the in-ear microphone.

Aspect 33: The method of any of aspects 20 through 32, wherein in a case where the audio output device corresponds to a first earbud, in a dual-earbud setup, that is associated with the transition to the quiet mode, the method comprising controlling a second earbud in the dual-earbud setup to transition to the quiet mode.

Aspect 34: The method of any of aspects 20 through 33, comprising applying, in the quiet mode, active noise cancelation to an audio signal based on the feed-forward circuit and independent of the feedback circuit, and obtaining an active noise-canceled version of the audio signal based on the applied active noise cancelation.

Aspect 35: The method of any of aspects 20 through 34, comprising outputting an active noise-canceled version of an audio signal independent of the in-ear microphone, using a speaker.

Aspect 36: An audio output device, comprising one or more memories; and one or more processors coupled to the one or more memories, the one or more processors individually or collectively configured to perform a method of any of aspects 1 through 35.

Aspect 37: An audio output device, comprising at least one means for performing a method of any of aspects 1 through 35

Aspect 38: A non-transitory computer-readable medium storing code for active noise cancelation (ANC) at an audio output device, the code comprising instructions executable by a processor to perform a method of any of aspects 1 through 35.

Aspect 39: An active noise cancelation (ANC) control device coupled to an ANC-enabled audio output device, the ANC control device comprising one or more memories; and one or more processors coupled to the one or more memories. The one or more processors individually or collectively configured to: obtain ambient sound information from the ANC-enabled audio output device; transition the ANC-enabled audio output device from a non-quiet mode to a quiet mode based on the obtained ambient sound information; and disable an ANC feedback circuit in the ANC-enabled audio output device based on the transition to the quiet mode.

It should be noted that the methods described herein describe possible implementations, and that the operations and the steps may be rearranged or otherwise modified and that other implementations are possible. Further, aspects from two or more of the methods may be combined.

As used herein, the phrase ‘one or more processors individually or collectively configured to’ may encompass various aspects, including but not limited to: processors that are programmed and capable of performing the function, regardless of whether execution is occurring at a given time; processors actively executing instructions to perform the function; and processors that, when triggered by an event or condition, initiate execution of the function. The scope of the phrase is not to limit the scope of the disclosure to an actively functioning device.

As used herein, the phrase ‘one or more processors individually or collectively configured to’ may encompass various aspects, including but not limited to: a single processor executing all functions; multiple processors, each performing different aspect of the function independently; multiple processors operating in coordination to execute a function collectively; or any combination thereof, where different processors may dynamically (e.g., concurrently or sequentially) assume responsibilities based on system conditions.

It is understood that the specific order or hierarchy of steps in the processes disclosed is an illustration of example approaches. Based on design preferences, it is understood that the specific order or hierarchy of steps in the processes may be rearranged. Further, some steps may be combined or omitted. The accompanying method claims present elements of the various steps in a sample order and are not meant to be limited to the specific order or hierarchy presented.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. An audio output device, comprising:
a feed-forward circuit configured to detect first ambient sound information;
a feedback circuit configured to detect in-ear sound information;
one or more memories configured to store a plurality of mode configurations comprising a quiet mode and a non-quiet mode; and
one or more processors coupled to the one or more memories, the one or more processors individually or collectively configured to:
transition from the non-quiet mode to the quiet mode based on the detected first ambient sound information; and
disable the feedback circuit based on the transition to the quiet mode.

2. The audio output device of claim 1, wherein the one or more memories are configured to store at least one sound profile associated with the quiet mode.

3. The audio output device of claim 2, wherein the one or more processors are individually or collectively configured to:
transition from the non-quiet mode to the quiet mode based on a similarity index, between the detected first ambient sound information and the at least one sound profile, exceeding a threshold value.

4. The audio output device of claim 2, wherein
the feed-forward circuit is configured to detect second ambient sound information in the quiet mode, and
the one or more processors are individually or collectively configured to maintain the quiet mode based on a similarity index, between the detected second ambient sound information and the at least one sound profile, exceeding a threshold value.

5. The audio output device of claim 2, wherein
the feed-forward circuit is configured to detect second ambient sound information in the quiet mode, and
the one or more processors are individually or collectively configured to:
transition from the quiet mode to the non-quiet mode based on a similarity index, between the detected second ambient sound information and the at least one sound profile, being below a threshold value; and
enable the feedback circuit based on the transition to the non-quiet mode.

6. The audio output device of claim 1, wherein
the one or more memories are configured to store a sound threshold associated with the quiet mode, and
the one or more processors are individually or collectively configured to:
transition from the non-quiet mode to the quiet mode based on the detected first ambient sound information being below the sound threshold.

7. The audio output device of claim 6, wherein the one or more processors are individually or collectively configured to transition from the non-quiet mode to the quiet mode based on the detected first ambient sound information being below the sound threshold for at least a configured time-period.

8. The audio output device of claim 6, wherein
the feed-forward circuit is configured to detect second ambient sound information in the quiet mode, and
the one or more processors are individually or collectively configured to maintain the quiet mode based on the detected second ambient sound information being below the sound threshold.

9. The audio output device of claim 8, wherein the one or more processors are individually or collectively configured to:
transition to the non-quiet mode from the quiet mode based on the detected second ambient sound information exceeding the sound threshold for a configured time-period; and
enable the feedback circuit based on the transition to the non-quiet mode.

10. The audio output device of claim 6, wherein the one or more memories are configured to store one or more sound profiles associated with the quiet mode.

11. The audio output device of claim 10, wherein
the feed-forward circuit is configured to detect second ambient sound information in the quiet mode, and
the one or more processors are individually or collectively configured to maintain the quiet mode based on a similarity index, between the detected second ambient sound information and at least one sound profile of the one or more sound profiles, exceeding a threshold value.

12. The audio output device of claim 10, wherein
the feed-forward circuit is configured to detect second ambient sound information in the quiet mode, and
the one or more processors are individually or collectively configured to:
transition to the non-quiet mode from the quiet mode based on a similarity index between the detected second ambient sound information and each of the one or more sound profiles being below a threshold value; and
enable the feedback circuit based on the transition to the non-quiet mode.

13. The audio output device of claim 1, comprising a power supply source coupled to the feed-forward circuit and the feedback circuit, wherein to disable the feedback circuit, the one or more processors are individually or collectively configured to suspend a power supply from the power supply source to the feedback circuit.

14. The audio output device of claim 1, wherein in a case where the audio output device corresponds to a first earbud, in a dual-earbud setup, that is associated with the transition to the quiet mode, the one or more processors are individually or collectively configured to control a second earbud in the dual-earbud setup to transition to the quiet mode.

15. The audio output device of claim 1, wherein
the feedback circuit comprises a feedback microphone and at least one of a filter or a gain controller, and
the feedback microphone is configured to detect the in-ear sound information in the non-quiet mode.

16. The audio output device of claim 1, wherein
the feed-forward circuit comprises a feed-forward microphone and at least one of a filter or a gain controller, and
the feed-forward microphone is configured to detect the first ambient sound information.

17. The audio output device of claim 16, wherein in a case where the feed-forward circuit comprises the gain controller, the one or more processors are individually or collectively configured to adjust a gain of the gain controller based on the detected first ambient sound information in the quiet mode.

18. The audio output device of claim 1, wherein based on the feedback circuit being disabled in the quiet mode, the one or more processors are individually or collectively configured to:
apply active noise cancelation to an audio signal based on the feed-forward circuit and independent of the feedback circuit; and
obtain an active noise-canceled version of the audio signal based on the applied active noise cancelation.

19. The audio output device of claim 1, comprising a speaker coupled to the one or more processors, wherein based on the disabling of the feedback circuit, the speaker is configured to output an active noise-canceled version of an audio signal independent of the feedback circuit.

20. An audio output device, comprising:
an out-ear microphone configured to detect ambient sound information;
an in-ear microphone configured to detect in-ear sound information;
one or more memories configured to store a plurality of mode configurations comprising a quiet mode and a non-quiet mode; and
one or more processors coupled to the one or more memories, the one or more processors individually or collectively configured to:
transition from the non-quiet mode to the quiet mode based on the detected ambient sound information; and
disable the in-ear microphone based on the transition to the quiet mode.
